(19) United States
(12) Patent Application Publication
(10) Pub. No.: US 2026/0315315 A1
(43) Pub. Date: Oct. 15, 2026

(54) Percussion Massager With Safety Mechanism

(71) Applicant: MerchSource, LLC, Irvine, CA (US)

(72) Inventors: Rene Jon Hart, New Canaan, CT (US); Keith Lawrence Covey, Costa Mesa, CA (US); Adam Sbeglia, Fullerton, CA (US); David Yang, Santa Ana, CA (US); Denny Liao, Tustin, CA (US); Lam Kiu, Kowloon (HK); Hui Hiu Kwan, Yuen Long (HK); Mark Filipek, Irvine, CA (US)

(21) Appl. No.: 19/642,570

(22) Filed: Apr. 8, 2026

Related U.S. Application Data
(60) Provisional application No. 63/788,718, filed on Apr. 14, 2025.

(51) Int. Cl. A61H 23/02; A61H 23/00

(52) U.S. Cl. CPC A61H 23/0254; A61H 23/006; A61H 2201/0153; A61H 2201/0176; A61H 2201/0285; A61H 2201/1436; A61H 2201/149; A61H 2201/1664; A61H 2201/1685; A61H 2201/5082; A61H 2201/5092

(57) ABSTRACT

A portable handheld percussion massager includes a massager housing, a motor, a power source, a piston driven by the motor in a reciprocating motion, and a massage node removably attachable to a distal end of the piston. A safety mechanism comprising a first component disposed on the piston and a second component disposed on the massage node prevents operation of the motor unless the massage node is properly attached. The first and second components may comprise electrical contacts, a mechanical switch, or a sensor and detectable feature. In one embodiment, electrical contacts on the piston and massage node are positioned within an electrical power path between the power source and the motor such that the power path is interrupted when the massage node is absent. In another embodiment, a controller determines a connection state between the electrical contacts and enables or disables the motor accordingly. Multiple interchangeable massage nodes, including temperature-controlled, light therapy, and ultrasonic vibration nodes, may be used with the safety mechanism.

### RELATED APPLICATIONS

This application claims the benefit under 35 U.S.C. § 119(e) of U.S. Provisional Patent Application Ser. No. 63/788,718, filed on Apr. 14, 2025, titled “PERCUSSION MASSAGER WITH SAFETY MECHANISM,” the entire contents of which are incorporated by reference herein.

### FIELD OF INVENTION

The present invention relates generally to handheld percussive massage devices and, more particularly, to a handheld percussion massager that includes an integrated safety mechanism designed to prevent operation of the device unless a massage node is properly attached to the percussive piston.

### BACKGROUND

Handheld percussion massagers have gained widespread popularity as therapeutic devices for muscle recovery, pain relief, and general wellness. These devices typically operate by converting rotational motion from an electric motor into rapid linear reciprocating motion through a crankshaft, connecting rod, and piston assembly, delivering percussive impacts to the user's body through a massage node or attachment coupled to a distal end of the piston. The piston typically reciprocates at frequencies in the range of approximately 1,000 to 3,500 or more percussions per minute, generating substantial force with each impact.

Many modern percussion massagers feature interchangeable massage nodes that allow users to select different attachment heads for different therapeutic purposes. For example, a user may select a flat-head node for broad muscle groups or a bullet-shaped node for targeted deep-tissue therapy. Users frequently interchange these massage nodes during a single therapeutic session to address different muscle groups or to apply different therapeutic modalities to the same area.

A significant safety concern arises when a user activates the percussion massager without a massage node properly attached to the reciprocating piston, or when a massage node becomes dislodged during operation. In such circumstances, the exposed reciprocating piston presents a substantial risk of injury. The piston may strike, pinch, or abrade exposed skin, particularly the user's fingers, which are in close proximity to the piston opening during massage node interchange. In certain configurations, the distal end of the piston may include mounting hardware such as threads or protrusions that can exacerbate the risk of injury upon contact with skin.

Conventional percussion massagers generally lack any mechanism to verify that a massage node is properly attached before permitting operation. Most prior art devices rely solely on the user's diligence to ensure proper attachment, which is insufficient, particularly in consumer-grade devices where users may be unfamiliar with proper attachment procedures. Some prior art devices employ friction-fit, press-fit, or threaded attachment mechanisms to secure the massage node to the piston, but these mechanisms do not provide any feedback to the device's control system regarding the attachment state of the massage node, nor do they prevent the motor from operating when the massage node is absent or improperly attached.

The risk of injury is particularly acute during massage node interchange. When a user removes one massage node and prepares to attach another, the piston aperture is exposed and the user's fingers are typically in close proximity to the piston. If the user inadvertently activates the device during this interchange, or if the device retains a powered state from a prior use session, the exposed piston may begin reciprocating before the user has attached the new massage node. Conventional devices provide no safeguard against this scenario.

Further, as massage nodes have become more sophisticated, incorporating active components such as thermoelectric heaters and coolers or light-emitting elements for phototherapy, an additional concern has emerged. These active massage nodes require electrical power from the massager to operate their therapeutic functions. Conventional massagers that support active massage nodes do not verify the identity or type of the attached node before delivering power. This creates a risk that incorrect power or control signals may be delivered to an unrecognized or incompatible massage node, which could damage the node, damage the massager, or deliver an unintended therapeutic effect to the user. Conventional devices also do not adjust their user interface or operational parameters based on the type of massage node attached, requiring the user to manually select the appropriate operating mode for each node type.

Accordingly, there exists a need in the art for a percussion massager that includes a safety mechanism capable of detecting whether a massage node is properly and securely attached to the reciprocating piston and preventing motor activation unless proper attachment is verified. There is a further need for such a safety mechanism that is robust, reliable, and capable of operating under the high-vibration, high-frequency percussive conditions inherent to percussion massager operation. There is also a need for a percussion massager that can identify the type of massage node attached and automatically adjust its operational parameters and user interface to correspond to the capabilities of the identified node type.

### SUMMARY OF INVENTION

The present invention relates to a portable handheld percussion massager incorporating a safety mechanism that prevents operation of the device unless a massage node is properly attached to the reciprocating piston.

In one aspect, the invention provides a percussion massager comprising a massager housing, a power source, a motor disposed within the massager housing and configured to receive power from the power source, a piston in operative communication with the motor and configured to reciprocate relative to the massager housing, and a massage node removably attachable to a distal end of the piston. The percussion massager further comprises a safety mechanism comprising a first component disposed on the piston and a second component disposed on the massage node, wherein the first component and the second component are configured to interact when the massage node is attached to the piston, and wherein the motor is operable when the first component and the second component are interacting and inoperable when the first component and the second component are not interacting.

In certain embodiments, the first component comprises one or more first electrical contacts disposed on or near the distal end of the piston, and the second component comprises one or more second electrical contacts disposed on the massage node, and the first component and the second component interact by the one or more first electrical contacts making electrical contact with the one or more second electrical contacts when the massage node is attached to the piston. The one or more first electrical contacts and the one or more second electrical contacts may be electrically interposed between the power source and the motor such that the motor is prevented from receiving electrical power from the power source when the electrical contacts are not in electrical contact with each other.

In certain embodiments, the first component comprises a mechanical switch disposed on or near the distal end of the piston, and the second component comprises a portion of the massage node that actuates the mechanical switch when the massage node is attached to the piston. The mechanical switch may be wired in series with an electrical circuit between the power source and the motor such that the motor is prevented from receiving electrical power from the power source when the mechanical switch is not actuated.

In certain embodiments, the first component comprises a sensor disposed on or near the distal end of the piston or within the massager housing, and the second component comprises a detectable feature of the massage node. The sensor may comprise at least one of an infrared emitter-detector, a Hall-effect sensor, a capacitive sensor, or an inductive coupling sensor. An output of the sensor may control a hardware switching element disposed in an electrical circuit between the power source and the motor.

In certain embodiments, the percussion massager further comprises a controller configured to monitor a state of interaction between the first component and the second component and to inhibit operation of the motor when the first component and the second component are not interacting with each other.

In certain embodiments, one of the one or more first electrical contacts or the one or more second electrical contacts comprises electrical pins and the other comprises electrical plates. The electrical plates may be concentrically arranged, and each electrical pin may be radially positioned to electrically contact a different one of the concentric electrical plates independent of a rotational orientation of the massage node when attached to the piston.

In certain embodiments, the massage node is removably attachable to the distal end of the piston via a threaded connection.

In another aspect, the invention provides a percussion massager comprising a massager housing, a motor disposed within the massager housing, a power source configured to supply electrical power to the motor through an electrical power path between the power source and the motor, a piston driven by the motor in a reciprocating motion within the massager housing, one or more first electrical contacts disposed on or near a distal end of the piston and positioned within the electrical power path, and a massage node removably attachable to the distal end of the piston. The massage node comprises one or more second electrical contacts positioned within the electrical power path and configured to make electrical contact with the one or more first electrical contacts when the massage node is attached to the piston. The electrical power path is interrupted at an interface between the piston and the massage node when the massage node is not attached to the piston, and the electrical power path is continuous through the interface when the massage node is attached to the piston.

In certain embodiments, the massage node is a first massage node comprising at least two second electrical contacts electrically interconnected within the first massage node by a conductive pathway, the at least two second electrical contacts configured to close an electrical circuit between the power source and the motor when the first massage node is attached to the piston. The percussion massager may further comprise a second massage node comprising at least three second electrical contacts, wherein at least two of the at least three second electrical contacts are configured to close the electrical circuit between the power source and the motor, and at least one of the at least three second electrical contacts is configured to deliver electrical power to an active component disposed within the second massage node. The active component may comprise a thermoelectric heater/cooler configured to impart a heating or cooling effect on a user through a contact medium of the second massage node.

In another aspect, the invention provides a percussion massager comprising a massager housing, a motor disposed within the massager housing, a power source, a piston driven by the motor in a reciprocating motion within the massager housing, one or more first electrical contacts disposed on or near a distal end of the piston, and a massage node removably attachable to the distal end of the piston. The massage node comprises one or more second electrical contacts configured to make electrical contact with the one or more first electrical contacts when the massage node is attached to the piston. The percussion massager further comprises a controller in communication with the motor and configured to determine a connection state between the one or more first electrical contacts and the one or more second electrical contacts, wherein the controller is configured to enable operation of the motor when the connection state indicates electrical contact and to disable operation of the motor when the connection state does not indicate electrical contact.

In certain embodiments, the controller is configured to continuously monitor the connection state during operation of the motor and to disable operation of the motor upon detecting a change in the connection state.

In certain embodiments, the percussion massager further comprises an indicator display disposed on the massager housing, and the controller is configured to activate the indicator display to alert a user when the connection state does not indicate electrical contact.

In another aspect, the invention provides a method of operating a percussion massager having a motor disposed within a massager housing, a piston driven by the motor in a reciprocating motion, one or more first electrical contacts disposed on or near a distal end of the piston, and a first massage node removably attachable to the distal end of the piston, the first massage node comprising one or more second electrical contacts. The method comprises attaching the first massage node to the distal end of the piston, thereby establishing a first electrical connection between the one or more first electrical contacts and the one or more second electrical contacts, enabling operation of the motor by establishing the first electrical connection, and inhibiting operation of the motor when the first massage node is not attached to the piston and the first electrical connection is not established.

In certain embodiments, the method further comprises detaching the first massage node from the distal end of the piston during operation of the motor, thereby breaking the first electrical connection between the one or more first electrical contacts and the one or more second electrical contacts.

In certain embodiments, the method further comprises detaching the first massage node and attaching a second massage node comprising one or more third electrical contacts to the distal end of the piston, thereby establishing a second electrical connection between the one or more first electrical contacts and the one or more third electrical contacts, and enabling operation of the motor upon establishing the second electrical connection.

In certain embodiments, enabling operation of the motor comprises completing an electrical power path between a power source and the motor through the one or more first electrical contacts and the one or more second electrical contacts, and inhibiting operation of the motor comprises physically interrupting the electrical power path at an interface between the piston and the first massage node.

In certain embodiments, the method further comprises monitoring, by a controller disposed within the massager housing, a state of the first electrical connection, and providing, by the controller, a visual indication to a user regarding an attachment state of the massage node based on the monitored state of the first electrical connection.

Other devices, apparatus, systems, methods, features and advantages of the invention are or will become apparent to one with skill in the art upon examination of the following figures and detailed description. It is intended that all such additional systems, methods, features and advantages be included within this description, and be within the scope of the invention, and be protected by the accompanying claims.

### DESCRIPTION OF FIGURES

The invention may be better understood by referring to the following figures. The components in the figures are not necessarily to scale, emphasis instead being placed upon illustrating the principles of the invention.

FIG. 1 illustrates a top side perspective view of one example of an implementation of a portable handheld percussion massager of the present invention.

FIG. 2 illustrates a top side perspective view of the portable handheld percussion massager of FIG. 1 with the side panel of the massager housing removed.

FIG. 3 illustrates a partially exploded perspective view of the portable handheld percussion massager of FIG. 2.

FIG. 4 illustrates an exploded perspective view of the portable handheld percussion massager of FIG. 1.

FIG. 5A illustrates a cross-section of the portable handheld percussion massager of FIG. 1 taken along line 5A-5A of FIG. 1.

FIG. 5B is an enlarged view of the encircled portion 5B of the portable handheld percussion massager of FIG. 5A.

FIG. 6 illustrates a cross-section of the portable handheld percussion massager of FIG. 1 taken along line 6-6 of FIG. 1.

FIG. 7 illustrates a side perspective view of another example implementation of a portable handheld percussion massager of the present invention.

FIG. 8 illustrates a side perspective view of the portable handheld percussion massager of FIG. 7 with the massage node removed.

FIG. 9 illustrates an exploded view of the massage node of FIG. 8.

FIG. 9A illustrates an exploded view of the light ring of FIG. 9.

FIG. 10 illustrates a side perspective view of the portable handheld percussion massager of FIG. 7 with the side panel of the massager housing removed.

FIG. 11 illustrates a side perspective view of the portable handheld percussion massager of FIG. 10 with the motor, piston and side panel of the massager housing removed.

FIG. 12 illustrates a cross-section of the portable handheld percussion massager of FIG. 7.

FIG. 13 illustrates a cut away view of the massage node of FIG. 7 showing the light ring turned off.

FIG. 14 illustrates a cut away view of the massage node of FIG. 7 showing the light ring operating in a first state or illuminating a first color.

FIG. 15 illustrates a cut away view of the massage node of FIG. 7 showing the light ring operating in a second state or illuminating a second color.

FIG. 16 illustrates a top side perspective view of a portable handheld percussion massager of the present invention having a rubber sleeve over the handle.

FIG. 17 illustrates a rear bottom perspective view of the portable handheld percussion massager of FIG. 16.

FIG. 18 is a block diagram of one example of an implementation of a portable handheld percussion massager of the present invention having the node affixed to the massager body.

FIG. 19 is a block diagram of one example of an implementation of a portable handheld percussion massager of the present invention having the node removably coupled to the massager body.

FIG. 20 is a block diagram of one example of an implementation of a portable handheld percussion massager of the present invention having an intelligent massage node.

FIG. 21 illustrates a side perspective view of yet another example implementation of a portable handheld percussion massager of the present invention.

FIG. 22 illustrates a side perspective view of the portable handheld percussion massager of FIG. 21 with the massage node removed.

FIG. 23 illustrates an exploded view of the massage node of FIG. 22.

FIG. 24 illustrates an opposing exploded view of a portion of the massage node of FIG. 23.

FIG. 24A is a bottom view of the heat sink of FIG. 24.

FIG. 25 is a cross-section of the massage node shown in FIG. 22.

FIG. 26 illustrates a side perspective view of the portable handheld percussion massager of FIG. 21 with the side panel of the massager housing removed.

FIG. 27 illustrates a side perspective view of the portable handheld percussion massager of FIG. 21 with the motor, exterior side walls of the piston and side panel of the massager housing removed.

FIG. 28 illustrates a cross-section of the portable handheld percussion massager of FIG. 21 with the massage node attached.

FIG. 29 illustrates a cross-section of the portable handheld percussion massager with massage node taken along line 29-29 of FIG. 28, showing the massage node in an unlocked position.

FIG. 30 illustrates a cross-section of the portable handheld percussion massager with massage node taken along line 29-29 of FIG. 28, showing the massage node in a locked position.

FIG. 31 illustrates a side perspective view of yet another example implementation of a portable handheld percussion massager of the present invention.

FIG. 32 illustrates a side perspective view of the portable handheld percussion massager of FIG. 31 with the massager housing removed.

FIG. 33 illustrates a front perspective view of one embodiment of the percussion massager of FIG. 31 having an electrical safety mechanism without the massage node attached.

FIG. 34 illustrates rear perspective views of multiple interchangeable massage nodes of the percussion massager of FIG. 33.

FIG. 35 illustrates a close-up view of the electric connection between the massage node and electrical contact terminals of the percussion massager of FIG. 33.

FIG. 36 illustrates a front perspective view of another embodiment of the percussion massager of FIG. 31 having a mechanical safety mechanism without the massage node attached.

FIG. 37 illustrates a front perspective view of yet another embodiment of the percussion massager of FIG. 31 having a sensor safety mechanism without the massage node attached.

### DETAILED DESCRIPTION OF THE INVENTION

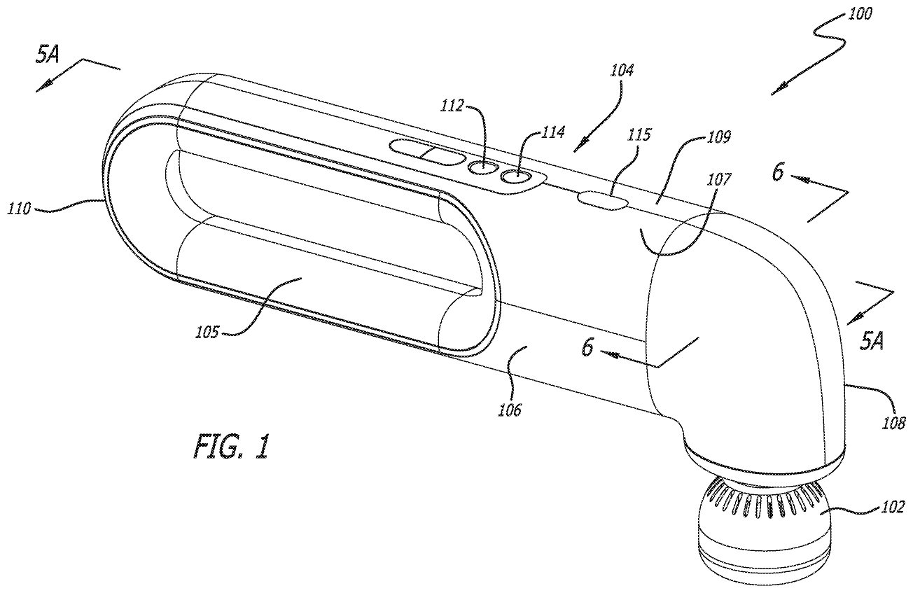

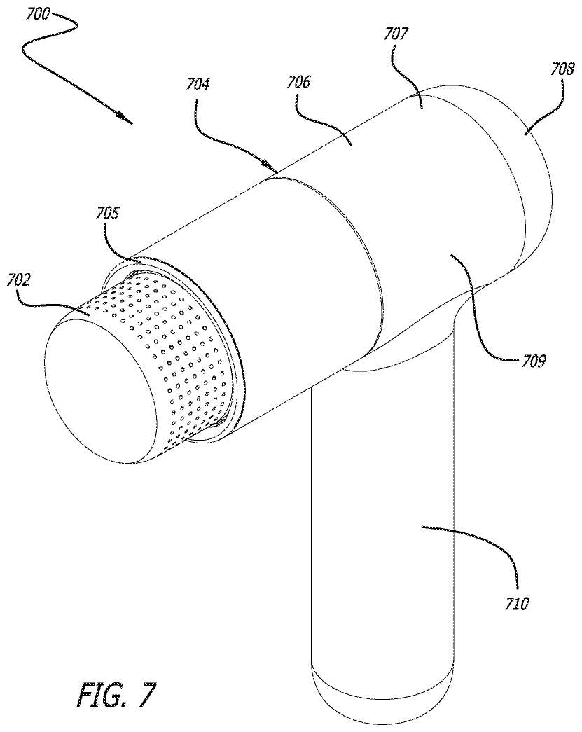

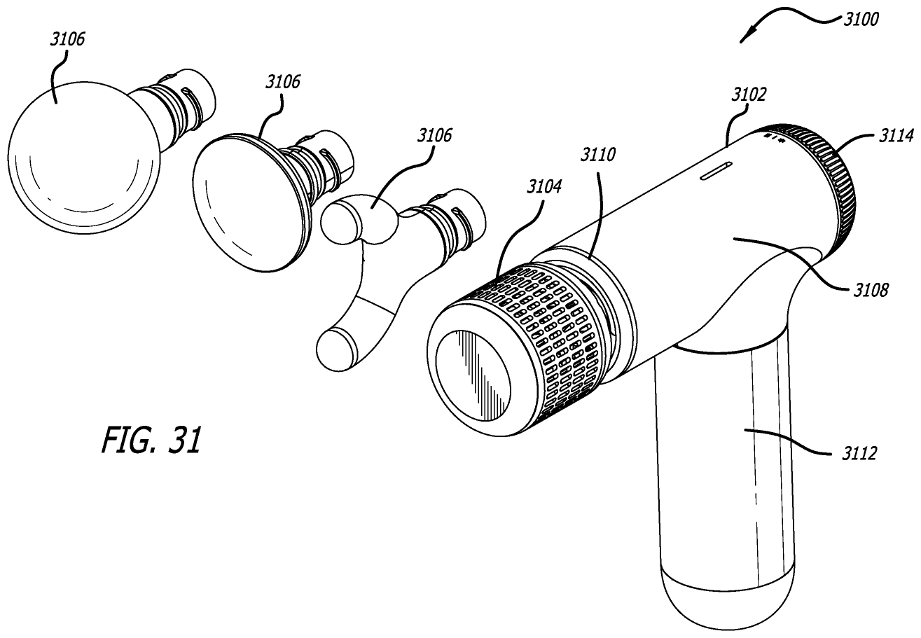

FIGS. 1-30 illustrate several examples of different implementations of a portable handheld percussion massager of the present invention that includes a temperature-controlled massage node which, as illustrated in FIGS. 1-6, may be affixed to the percussion massager, or may be removably attached, as illustrated in FIGS. 7-17, FIGS. 21-30 and FIGS. 31-39. Further, the temperature-controlled massage node may be powered by the same power source as the percussion massager or may include an independent power source located, for example, in the massage node. In all examples, the temperature-controlled massage node of the present invention is designed to impart either or both a heating or cooling effect to different locations of a user's body with the percussive massage effect, or optionally, without the percussive massage effect. It should be understood that all features and functions described in connection with all percussion massager embodiments herein may be incorporated in combination with each other. For example, all features and functions described in connection with FIGS. 1-30 may be incorporated in any of the embodiments described in connection with FIGS. 31-39, and vice versa.

For purposes of this application, when the node is referred to as “affixed” to the percussion massager, it means that the node is not intended to be a removable attachment. While the node may be permanently attached or physically removably (in that the node is a separate piece from the massager), when a node is deem affixed to the percussion massager, it is connected to the massager in a manner not intended to be removable by the user. In other words, an affixed node is distinguishable from a removably attached or removeable coupled node; however, both removably attached nodes and affixed nodes are attached to the percussion massager for use.

While the examples illustrated in FIGS. 1-39 show a portable hand-held massager using a motor, with a percussion assembly, to impart a percussive massage effect on the massage node, it is recognized that the present invention may be embodied in any type or shape of massager, including those imparting only vibration upon the user. For example, the present invention may be used in a massager taking the form of a massage gun, which is typically recognized as a piston, attached to a rod and crankshaft, all driving by a motor, that provides rapid, percussive tapping, which gun may include different piston attachments for imparting different massage effects. The present invention may also take the form of a wand-type massager or other hand-held massage apparatus that may impart, for example, only a vibrating massage effect, with either a removable massage node or affixed massage node.

The massage nodes referenced throughout this specification are referred to as “temperature-controlled” massage node. “Temperature-controlled” as used in this specification shall mean a massage node that is able to operate at different temperatures than ambient temperature. For example, a “temperature-controlled” massage node may be a massage node that is able to be either or both heated or cooled, each at a single temperature, or alternatively at a range of temperatures.

While the examples below discuss the inclusion of a thermoelectric heater/cooler, such as a Peltier plate, to vary the temperature imparted by the massage node on the user, a heat element or cooling element could be provided in place of the thermoelectric heater/cooler, such that the massage node of the present invention only imparts heat or cold effects on the user (but not both). In this regard, heating elements, such as heating films or heating plates can be used in place of the Peltier plate to impart heating effects on a user. Additionally, if only heating or cooling is desired for a particular application, a Peltier plate may still be used, by providing for the current to flow through the Peltier plate in only one direction.

Further, while the percussion massager of the present invention is referenced throughout the specification in a single orientation, it should be understood that the percussion massager described herein can be used in various orientations and is not limited to use in the orientations illustrated in the drawings and described in the specification. Direction terms are used only with respect to the orientation of the percussion massager as illustrated in the drawings.

FIG. 1-6 illustrate one example implementation of a portable handheld percussion massager 100 of the present invention that includes a temperature-controlled massage node 102 that, in this example, is affixed to the percussion massager 100. As illustrated in FIG. 1., which is a top side perspective view of a portable handheld percussion massager 100, the portable percussion massager 100 includes a massager housing 104, which includes central housing 106, forward housing 108, and rearward housing 110. In this example, the central housing 106, forward housing 108 and rearward housing 110 may be three separate pieces, with the central housing 106 and forward housing 108 each having right 107 and left 109 side panels that engage with one another to form a hollow massager housing 104. It should be understood, however, that the massager housing 104 may be made from any number of different pieces formed together or separately.

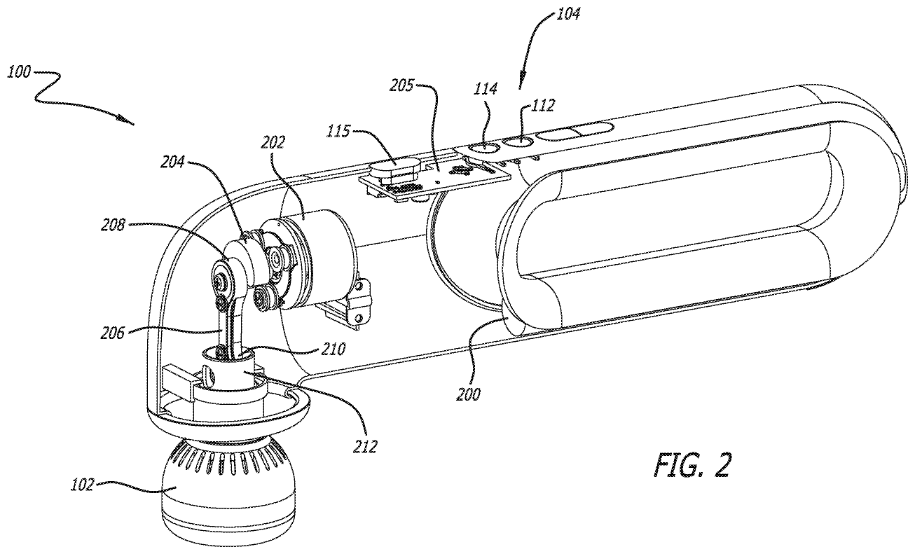

Also illustrated in FIG. 1, the percussion massager 100 includes a handle 105 which may be formed as part of the central and rearward housing 106, 110 as illustrated, or may be a separate piece extending from the massager housing 104 (as shown in FIGS. 7-17). In alternative implementations, the housing 104 may form a handle 105. Positioned on the massager housing 104 are controls 112 and 114, which allow the user to control the operation of the percussion massager 100. For example, the user may turn the percussion massager 100 on and off using user controls 112 and/or 114 or separate controls (not shown). The user can also use controls 112 and/or 114 to control the various speeds of the motor 202 (FIG. 2) to create different percussion massage effects and further control the hot and cold effects imparted by the temperature-controlled massage node 102 when the heating and cooling effects are engaged.

An indicator display having indicator light(s) 115 may also be provided on the massager housing 104 to communicate the state of the operation of the percussion massager 100 to the user. Indicator lights 115 may be one or more light emitting diode (LED) mounting on a mounting surface that illuminate, for example, when the massager is on. Indicator lights 115 may further be illuminated to indicate the speed of operation of the motor 202 of the percussion massager 100. Indicator lights 115 may also be illuminated to indicate whether the temperature-controlled massage mode 102 is operating, whether the temperature-controlled massage nodes 102 are operating in a heating mode or a cooling mode (e.g., a first hue or second hue, red or blue, or a shade of red/shade of blue), and/or at which preset temperature the temperature-controlled massage node 102 is operating.

FIG. 2 illustrates a top side perspective view of the portable handheld percussion massager 100 of the present invention with the side panel 109 of the central housing 106 and forward housing 108 (see FIG. 1) removed. Contained within the housing 104 is a power source 200, which in this case is a rechargeable battery, a motor 202 and a circuit board 205. The circuit board 205 operates as a controller for controlling the operation of the motor 202 and/or the heating and cooling effects of the temperature-controlled massage node 102. The circuit board 205 is in communication with, or electrically connected to, the power source 200. The battery 200 provides power to the circuit board, and may provide power directly to the motor, or indirectly to the motor through the circuit board, either of which provides the necessary power to the motor 202. The battery 200 may be comprised of lithium-ion battery cells connected in series to produce the voltage necessary to power the percussion massager 100, which may for example, consist of a series of cells producing approximately 25+ volts when fully charged. Such battery cells are commercially available from many different suppliers. The motor 202 may be a brushless DC electric motor having a shaft that rotates in response to electrical energy. The electric motor 202 may be, for example, a 24-volt brushless DC motor, of a type and brand a commercially available, or other type and sized motor suitable for the particular size and application of the portable massager 100.

Optionally, the power source 200 may be one or more batteries, one or more rechargeable batteries, and/or the percussion massager 100 and/or the massage node 102 may draw power through an external power source by, for example, plugging into a power outlet, such as a 110-volt outlet, to operate the massager 100, to recharge the batteries, or both. As stated before, the massage node 102 may draw power from the same power source as the massager 100 or may be powered independent from the massager 100 through one or more batteries, rechargeable batteries or through an external power source.

The motor 202 is provided to drive the temperature-controlled massage node 102 in a percussive motion. Alternatively, the motor 202 could be provided to impart only a vibrating massage effect, only a percussive massage effect or both. In the illustrated example, the motor 202 includes a crankshaft 204 that rotates about a central axis of the motor 202 via a motor shaft. A rod 206 having a first end 208 and second end 210 is then coupled at its first end 208 to the crankshaft 204 at a point offset from the rotational axis of the crankshaft 204. Attached to the second end 210 of the rod 206 is a piston 212 (or percussion driver), which has a temperature-controlled massage node 102 coupled to the piston 212 on its end 210 opposing the crankshaft 206.

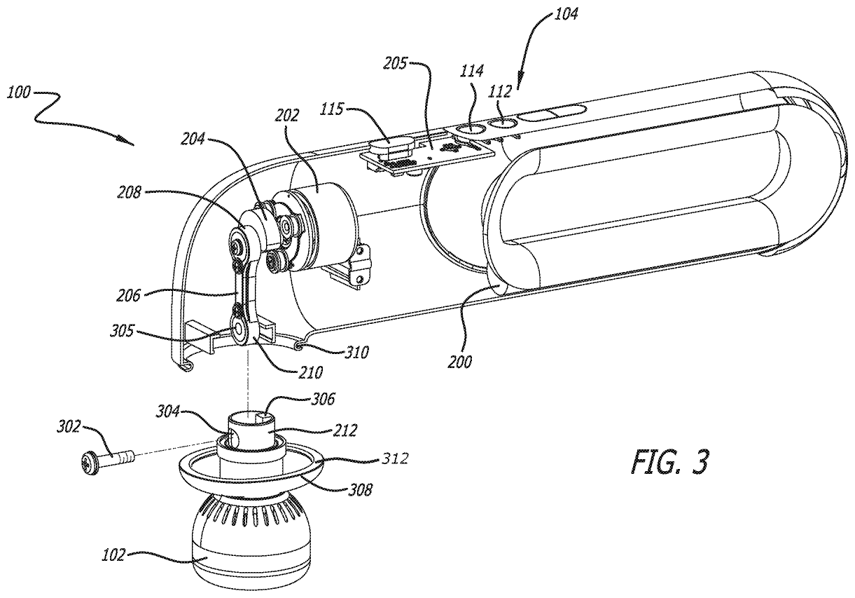

FIG. 3 illustrates a partially exploded perspective view of the portable handheld massager of FIG. 2. Here, the piston 212 and massage node 102 are shown removed from the rod 206. In this example, the piston 212 is attached to the second end 210 of the rod 206 with a screw 302 which is positioned through an opening 304 in the piston 212 and through a corresponding opening 305 on the second end 210 of the rod 206 when the rod 206 is inserted in the piston 212. Once through the opening 305 in the rod 206, the screw 302 is then secured against a brace 306 positioned against an interior wall of the piston 212. Despite being attached to the brace 306, the piston 212 remains generally hollow to allow for electrical wires to extend through the piston 212 to power the temperature-controlled massage node 102, and other possible components positioned with the massage node 102.

A flexible cover 308 is also provided above and around the massage node 102 (as oriented in FIG. 3) to close the massager housing 104 above the massage node 102. In this example, an interior edge 312 extending inward from the flexible cover 308 attaches to a perimeter channel 310 on the forward housing 108. The flexible cover 308 allows the piston 212 to move the massage node 102 up and down with the movement of the crankshaft 204 and rod 206 as they are driven by the motor 202 while allowing the massager housing 104 to remain closed.

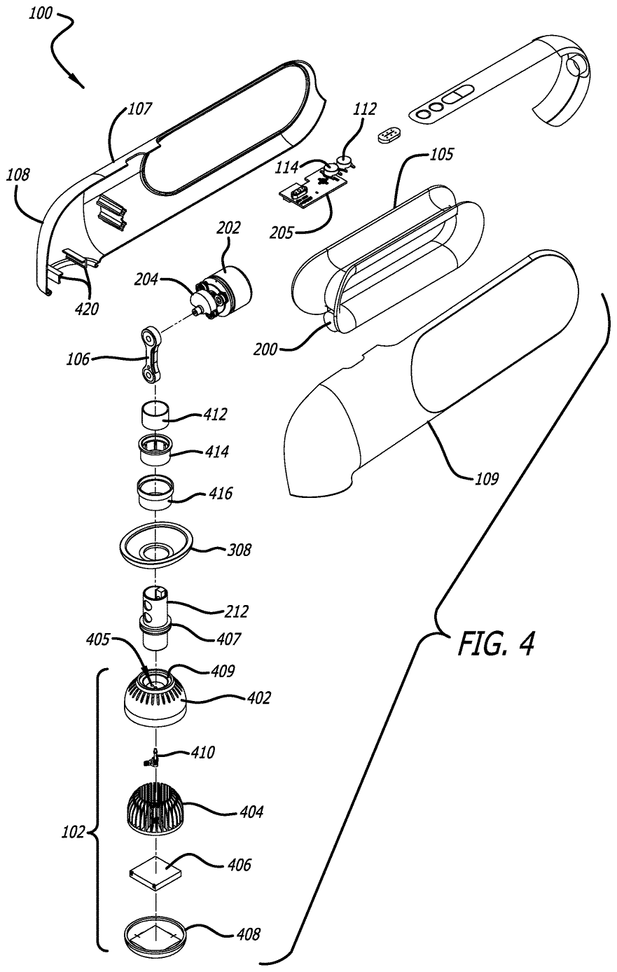

FIG. 4 illustrates an exploded perspective view of the portable handheld percussion massager 100 of FIG. 1. FIG. 4 best illustrates the component parts of the temperature-controlled massage node 102. Temperature-controlled massage node 102 includes a node housing 402, a heat dissipating or absorption device 404, and at least one thermoelectric heater/cooler 406, often referred to as a Peltier plate or chip, and a contact medium 408 for covering the Peltier plate 406 to help dissipate the heating and cooling effect of the Peltier plate 406 and transfer the heating or cooling effect to the user. The contact medium 408 may be, for example, be an aluminum or stainless-steel plate (or other thermal conductive metal) and may be formed as part of the node housing 402 or be a separate piece from the node housing 402. As set forth above, the contact medium 408 may include a softer material used in connection with the thermal conductive plate 408, for example as a cover, or alternatively, in place of the thermal conductive plate 408, such as a thermal conductive cloth-like pad or material, which may be made, for example, from cloth, plastic, graphite, carbon fiber and/or a silicon material (such as a gel or resin) having conductive fibers, to name a few examples.

The heat dissipating or absorption device 404 may be, as illustrated, a heat sink, which in this example may be made of metal. Optionally, the percussion massager 100 or temperature-controlled massage node 102 may further or alternatively include a fan for active cooling. Further, the housing 402 may be designed to operate as the heat dissipating or absorption device 404 or may assist the heat dissipating or absorption device 404, for example, by incorporating venting in the housing. For example, perforations, may be incorporated into the housing 402.

A thermal conductor (not shown), such as a thermal paste, may be positioned between the Peltier plate 406 and the contact medium 408 to transfer heat and/or cold between the Peltier plate 406 and the contact medium 408. The Peltier plate 406 may be, for example, a single Peltier chip with reverse polarity for heating and cooling. While the illustrated examples show the use of only one single Peltier plate or chip 406, more than one plate or chip may also be utilized in different configurations, such as by stacking the chips or positioning the chips side-by-side.

While the temperature-controlled massage node 102 of the present invention may be attached or affixed to the piston 212 or, alternatively may be removably coupled to the piston 212, the example illustrated in FIG. 4 illustrates the temperature-controlled massage node 102 attached to the piston 212. Here, the node housing 402 includes a top cylindrical recessed portion 405 for receiving the bottom end of the piston 212. The piston 212 includes two spaced apart annular rings 407 surrounding the piston 212 near its center creating a groove between the annular rings 407. The groove created by the rings 407 receives a corresponding circular tongue 409 on the flexible cap 308 to retain the flexible cap 308 against the piston 212.

At least one electrical connector or contact 410 is also positioned directly under the cylindrical recessed portion 405 of the node housing 402 in the center of heat sink 404 and in communication with the Peltier plate 406 to provide power to the Peltier plate 406. Openings in the top of the cylindrical recessed portion 405 of the node housing 402 allow for flexible wires (not shown) to contact the electrical contacts 410 to power the Peltier plate 406. Flexible wires draw electricity from the power source 200 in the massager housing 104 and extend from the circuit board 205 through the center of the piston 212 to contact the electrical connectors 410. The flexible wires must maintain enough slack when attached to the electrical connectors 410 to prevent the contacts from detaching from the connectors 410 during use and/or while the temperature-controlled massage node 102 percusses. Further positioned around the top of the piston 212 above the flexible cap 308 is a slidable sleeve 412, a middle sleeve 414 and an outer sleeve 416 which engage the mounting brackets 420 positioned on the interior of the forward housing 108.

Alternatively, similar to when the temperature-controlled massage node 102 is removably coupled to the piston 412 (as will be explained further below), the piston 412 may include electrical contact pins, plates, leaf spring plates, rings or pin receptacles and the temperature-controlled massage node 102 may include a corresponding electrical contact pins, plate, leaf spring plate, or ring to close the circuit in communication with the Peltier plate 406 for mating with the electrical contacts of the piston 412 when the temperature-controlled massage node 102 is coupled to the piston 212 to provide power to the Peltier plate 406.

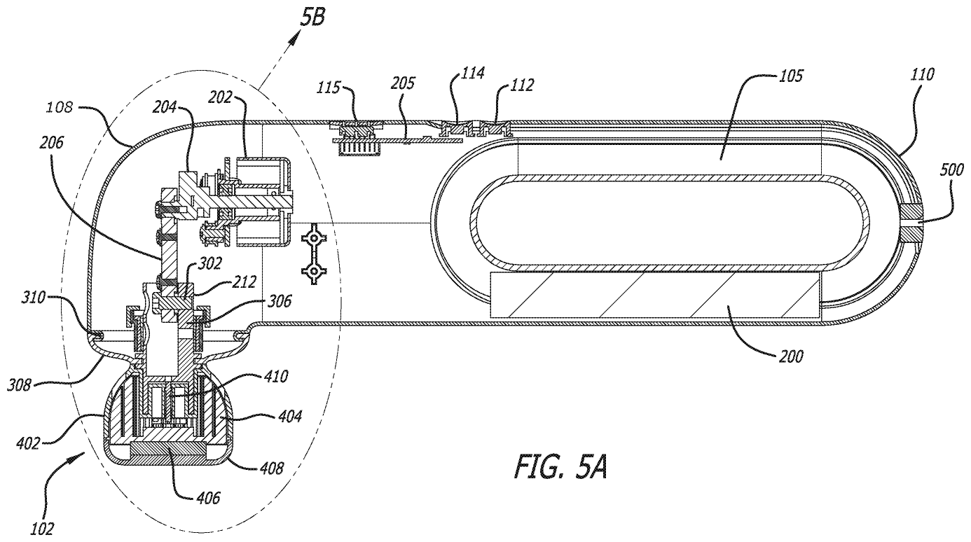

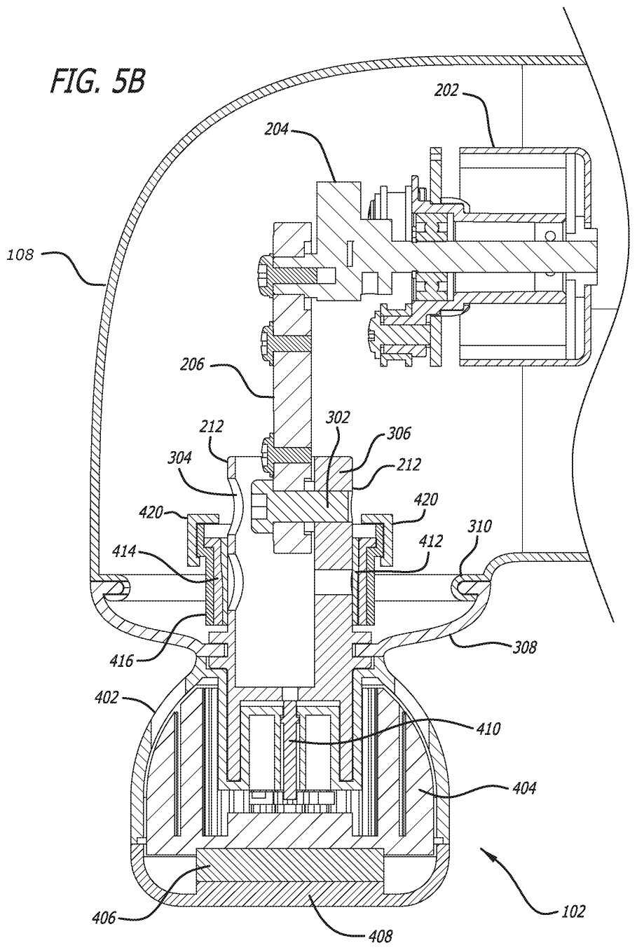

FIG. 5A illustrates a cross-section of the portable handheld percussion massager 100 of FIG. 1 taken along line 5A-5A of FIG. 1. FIG. 5B is an enlarged view of the encircled portion 5B of the handheld percussion massager of FIG. 5A. FIGS. 5A and 5B together illustrate the attachment of the temperature-controlled massage node 102 to the piston 212 and forward housing 108.

As illustrated in FIGS. 5A and 5B, motor 202 rotatably drives the crankshaft 204 which is coupled to the rod 206, where the rod 206 is attached to the crankshaft 204 offset from the rotational axis of the crankshaft 204. Rod 206 is then attached to the piston 212 at its end opposing the crankshaft 204, and the piston 212 is attached to the massage node 102. Massage node 102 includes a node housing 402 which receives the end of the piston 212 opposing its attachment to the rod 206. Electrical contacts or connections 410 are exposed through top of the node housing 402 under the piston 212 to make electrical connections or contact with flexible wires extending from the circuit board 205 through the hollow center of the piston 212. Electrical contacts 410 provide power to the Peltier plate 406 which is positioned under the heat sink 404. Heat sink 404 is positioned under and around the piston 212 within the node housing 402. A contact medium 408 is also provided over the Peltier plate 406 to prevent direct contact by a user with the Peltier plate 406. Also shown on FIG. 5A is an electrical connector 500 for recharging the battery 200.

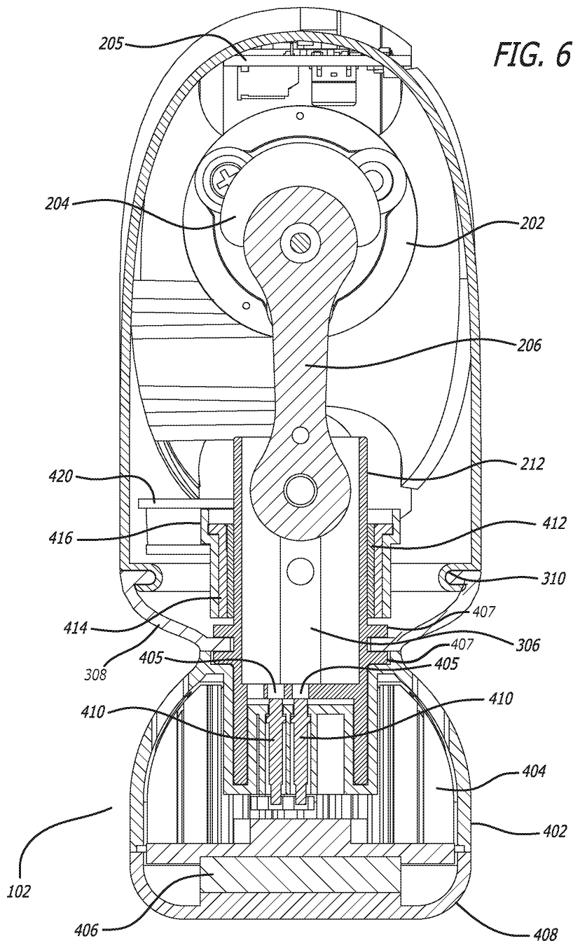

FIG. 6 illustrates a cross-section of the handheld percussion massager 100 of FIG. 1 taken along line 6-6 of FIG. 1. FIG. 6 illustrates the connection of the rod 206 to the piston 212 along the hollow upper portion of the piston 212. Electrical contacts 410 are best seen in FIG. 6, which also illustrates the exposure of the electrical contacts 410 to the hollow cylindrical opening in the piston 212. The Peltier plate 406 is positioned between the heatsink 404 and the contact medium 408 in communication with the electrical contacts 410. The two rings 407 on the piston 212 having an annular groove between the rings 407 that engage the tongue on the flexible cap 308 is also seen in FIG. 6.

Electrical contacts 410 are positioned in the node housing 402 in the center of heat sink 404 and in communication with the Peltier plate 406 to provide a power to the Peltier plate 406. Openings in the top of the cylindrical recessed portion 405 of the node housing 402 align with openings in center of the piston 212 to allow for flexible wires (not shown) to contact the electrical contacts 410 to power the Peltier plate 406. The slidable sleeve 412, middle sleeve 414 and outer sleeve 416 which engage the mounting brackets 420 positioned on the interior of the forward housing 108 around the top of the piston 212 above the flexible cap 308 is also best seen in FIG. 6.

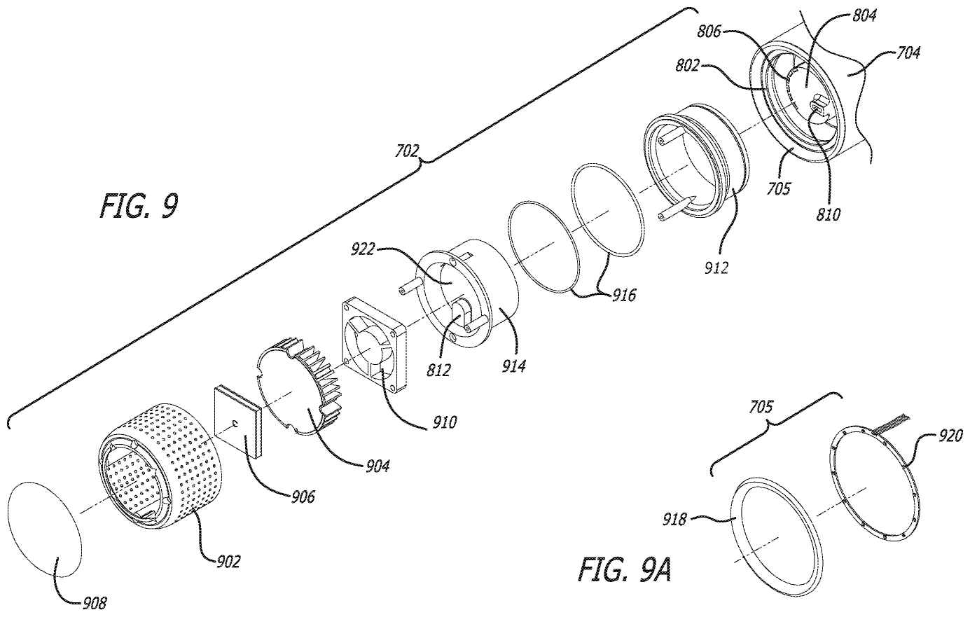

FIG. 7-15 illustrate yet another example of an implementation of the present invention. In FIG. 7-15, temperature-controlled massage node 702 is illustrated that can be removable coupled to a portable handheld percussion massager 700. In this example, a light ring 705 is also positioned on the body of the massager to indicate the state of the temperature-controlled massage node 702. In this example, the light ring 705 is an annular ring coupled or attached to the front end peripheral edge of the massager body or housing 704. While illustrated at attached to the front peripheral edge of the massager body or housing 704, the light ring could be integrated anywhere along the massager body or housing 704. Optionally, the light ring 705 could also be made part of the temperature-controlled massage node 702 itself, for example, by incorporating the light ring 705 into the node housing 902 (FIG. 9).

FIG. 7 is a side perspective view of the portable handheld percussion massager 700. As illustrated in FIG. 7, the portable percussion massager 700 includes a massager housing 704 having a main body 706, rear panel 708 and a handle 710. In this example, the handle 710 may be formed extending downward from the main body 706. The main body 706, rear panel 708 and a handle 710 may be constructed from one or more pieces to form a hollow massager housing 704. For example, the main body 706 and the handle 710 may be constructed from be two separate pieces-a right side piece 707 and a left 709 side piece that engage one another to form a hollow massager housing 704. The rear panel 708 may also be a separate piece engaged to the rear of the main body 706. These examples are not limiting. The massager housing 704 may be made from any number of different pieces formed together or separately.

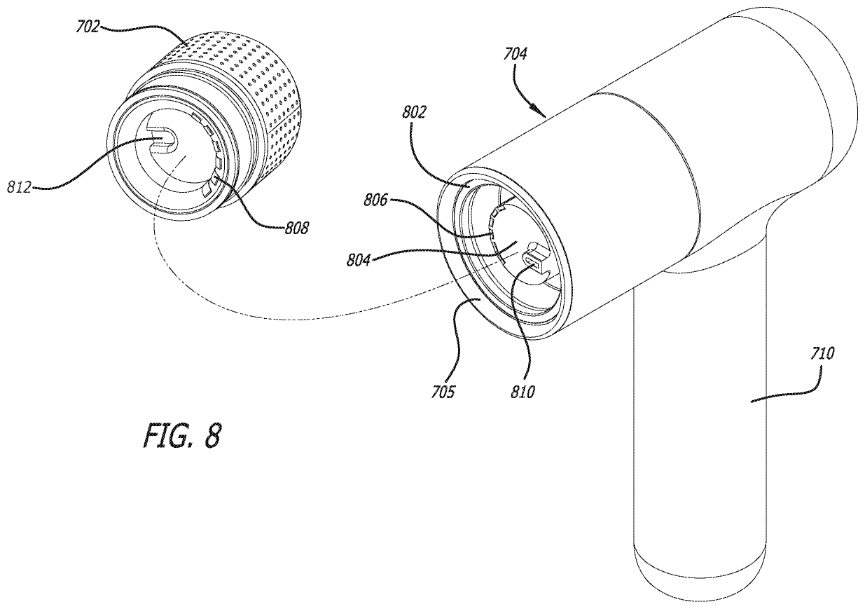

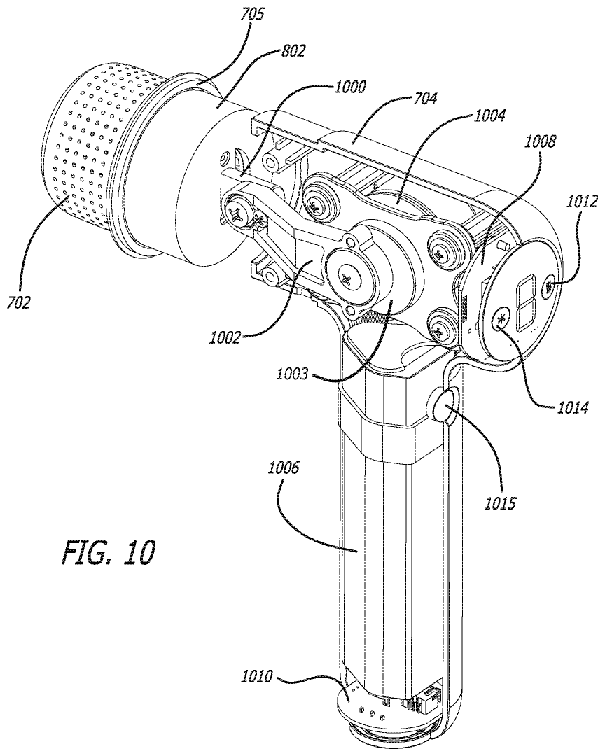

FIG. 8 illustrates a side perspective view of the portable handheld percussion massager 700 of FIG. 7 with the massage node 702 removed. As shown, the massage node 702 is removably coupled to a node mount 802 that is driven by the massage piston 1000 (FIG. 10). Here, the massage node 702 is attached to a node mount 802 though a friction fit or press fit, that creates an interference or transition type fit; however, other known mechanisms for coupling the massage node 702 to the node mount 802 may be provided, including but not limited to, for example, threading. As will be explained further below, and shown in connection with FIG. 9, in the illustrated example, the massage node 702 includes at least one sleeve or shaft having component parts that couple with parts on the interior of the node mount 802 to removably couple, through a press fit, the massage node 702 to the massage housing 704.

In this example, the node mount 802 includes a mating pad 804 having at least one electrical contact pin, plate or leaf spring plate 806 for making contact with at least one corresponding electrical contact pin, plate or leaf spring plate 808 on the massage node 702. The corresponding electrical contact pin, plate or leaf spring plate 808 on the massage node 702 are in communication with a thermoelectric heating and cooling device 914 (FIG. 9) when the temperature-controlled massage node 702 is coupled to the node mount 802. The node mount 802 further includes a male connector 810 on the mating pad 804 that corresponds to a female connector 812 in the massage node 702 for aligning the massage node 702 when inserted into the massager housing 704 such that the electrical contact pins and/or plates 806 and 808 align to make electrical contact. As set forth above, the electrical contacts 804 and 806 may be electrical contact pins, plates, leaf spring plates or rings. Optionally, contactless charging may also be used.

FIG. 9 illustrates an explode view of the massage node 702 of FIG. 8. In this example, temperature-controlled massage node 702 includes a node housing 902, a heat dissipating or absorption device 904, and at least one thermoelectric heater/cooler 906, often referred to as a Peltier plate or chip, and a contact medium 908 for covering the Peltier plate 906 to help dissipate the heating and cooling effect of the Peltier plate 906 and transfer the heating or cooling effect to the user. The heat dissipating or absorption device 904 may be, as illustrated, a heat sink, which in this example may be made of metal. The contact medium 908 may be, for example, be an aluminum or stainless teel plate (or other thermal conductive metal) and may be formed as part of the node housing 902 or be a separate piece from the node housing 902. As with the prior example in FIGS. 1-6, a softer material may be used in connection with the thermal conductive plate or in place of the thermal conductive plate, such as a thermal conductive cloth like pad or material, which may be made, for example, from cloth, plastic, graphite, carbon fiber and/or a silicon material (such as a gel or resin) having conductive fibers, to name a few examples.

Optionally, the percussion massager 700 or temperature-controlled massage node 702 may further or alternatively include a fan 910 for active cooling. In this illustration, the fan 910 is positioned underneath the heat sink 904 is in communication with the electrical contact pins and/or plates 808 to power the fan 910 when the node 702 is coupled to the massager housing 704. To couple the massage node 702 to the housing, the massage node 702 includes at least one mounting sleeve or shaft for coupling the massage node 702 to the massager body or housing 704, which in this example, includes an outer sleeve 912 and inner sleeve 914 and sealing rings 916 positioned therebetween. The outer sleeve 912 includes grooves for interlocking with corresponding grooves on the interior of the massage node mount 802 for creating a friction fit between the massage node 702 and massager housing 704, when the massage node 702 is inserted in the massage node mount 802 of the massager housing 704.

The inner sleeve 914 includes a recessed plate 922 for receiving the mating pad 804. The recessed plate 922 includes the female connector 812 for receiving the male connector 810 of the mating pad 804 and electrical contact pins or plates 808 for contacting and aligning with the electrical contact pins or plates 806 on the mating pad 804.

Also, shown in FIG. 9A is light ring 705 as it would appear removed from the massager housing 704. The light ring 705 functions as an indicator display and includes a transparent or translucent light ring cap 918 and a circular light emitting diode (LED) ring mount 920, having at least one or a plurality of LEDs positioned about the LED ring mount 920 on the surface of the mount (i.e., mount surface). The light ring mount 902 is then electrically connected to the printed circuit board (PCB) or controller 1008 (FIG. 10) to control the operation of the LED(s). The LED(s) may include single, dual or multicolor LEDs, connected in series or parallel, that can be activated to illuminate together or separately to display different colors, resulting in the illumination of one or more same color LED or one or more LEDs of differing colors to produce different visible illuminating effects. The one or more LEDs position on the ring mount can be electrically connected to one or more of the LEDs on the ring mount or directly to the PCB 1008. The at least one LED or plurality of LEDs are controlled by the PCB 1008 for illumination upon the occurrence of certain operations of the massager 700 or the massage node 702.

While the light ring 705 is illustrated attached or coupled to the massager body 704, it could alternatively be included as part of the massage node 702, by integrating the light ring 705 with, or attached above or below, the node housing 902. In this manner, power can be supplied to the light ring 705 by a power source in the massage node 702. Power may also be supplied to the light ring 705 on the massage node 702 by a power source in the massage body 704 to illuminate the LEDs in the light ring 705 in the same manner as the thermoelectric heating and cooling device 914 (FIG. 9) receives power. For example, if the light ring 705 is integrated into the massage node 702, corresponding electrical contact pin, plate or leaf spring plate 808 on the massage node 702 could be connected to, or in communication with, the light ring 705 to power to the light ring 705. When included with the massage node 702,

Again, a thermal conductor (not shown), such as a thermal paste, may be positioned between the Peltier plate 906 and the contact medium 908 to transfer heat and/or cold between the Peltier plate 906 and the contact medium 908. The Peltier plate 906 may be, for example, a single Peltier chip with reverse polarity for heating and cooling. While the illustrated examples show the use of only one single Peltier plate or chip 906, more than one plate or chip may also be utilized in different configurations, such as by stacking the chips or positioning the chips side-by-side.

FIG. 10 illustrates a side perspective view of the portable handheld percussion massager 700 of FIG. 7 with the right-side panel of the massager housing 704 removed. As shown, the portable handheld percussion massager 700 includes a piston 1000, rod 1002 and crankshaft 1003 driven by a motor 1004 via a motor shaft, which imparts a percussion massage effect on the node mount 802 that drives the nodes 702 connected thereto. The piston 1000 is coupled to the node mount 802, that then couples to the massage node 702, as illustrated in FIG. 9. The motor 1004 rotatably drives a crankshaft 1003 which is coupled to the piston 1000 by rod 1002 to create a percussive massage effect by moving the node mount 802 and coupled massage node 702.

As with the example in FIGS. 1-6, a battery 1006 and circuit board/controller 1008 are also provided to control the operation of the massager 700. All the same optional power sources that were discussed in connection with FIGS. 1-6 are applicable to this example massager 700, including the massage node 702 having its own independent power source to control its operation from hot to cold, and or even to provide a vibrating massage effect in addition to, in combination with, or absent any percussive massage effect.

Further, in the illustrated example, controls 1012, 1014 and 1015 may be positioned on the massager housing 704, with, for example, a liquid crystal display, that allows users to monitor and control the operation of the percussion massager 700. For example, the user may turn the percussion massager 700 on and off using user control 1015 or may also use other separate controls (not shown). The user can also use controls 1012 and/or 1014 to control the various speeds of the motor 1004, to create different percussion massage effects and further control the hot and cold effects imparted by the temperature-controlled massage node 702 when the heating and cooling effects are engaged. Additional controls/lighting elements 1010 may also be provided in certain implementations to convey further operational information to the user and/or allow the user to control other operations of the massager 700.

As described above and further explained below, a light ring 705 may also be provided on the massager housing 700 to communicate the state of the operation of the percussion massager 700 and/or the massage node 702 to the user. Here, the light ring 705 may include one, more or a plurality of LEDs, which may be either or both single, dual or multicolor LEDs that may be illuminated, for example, when the massager 700 is on or, in response to, or corresponding with, certain operational conditions. The LEDs may light all together, may illuminate with less than all of the LEDs (for example half at a time) or may illuminate in sequence or on another pre-programmed routine or schedule to create different lighting effects. The LEDs may function alone or in connection with other lights on the massager 700 as indicator lights or an indicator display that may be illuminated to indicate any number of operational conditions. For example, indicator lights may indicate the speed of operation of the motor 1004 of the percussion massager 700. Indicator lights may also be illuminated to indicate whether the temperature-controlled massage mode 702 is operating, whether the temperature-controlled massage nodes 702 are operating in a heating mode or a cooling mode (e.g., red verse blue LED lights), at which preset temperature the temperature-controlled massage node 702 is operating, the state of the battery and/or the speed of the motor, among other things. For example, the LEDs may illuminate different hues of light for different operation, a first hue, second hue, or a shade of red/shade of blue, etc.

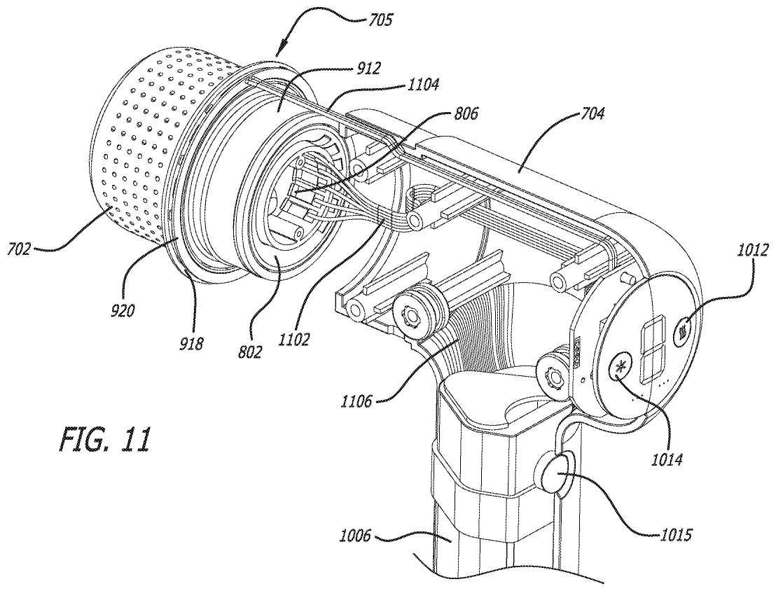

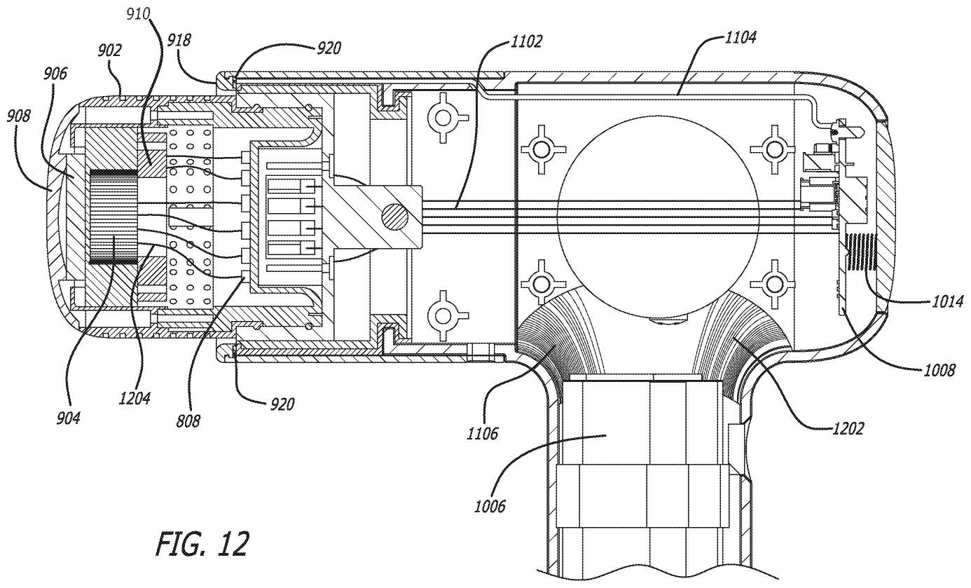

FIG. 11 illustrates a side perspective view of the portable handheld percussion massager 700 of FIG. 10 with the motor 1004, crankshaft 1003, rod 1002 and left side panel 709 of the massager housing 704 removed to expose the circuity of the massager 700. As shown, electrical circuitry 1106 runs from the battery 1006 to power the motor 1004 and electrical circuitry 1202 (FIG. 12) from the battery 1006 to the PCB/controller 1008. Electrical circuity 1102 also runs from the circuit board 1008 to the electrical contact plates 806 on the mating pad 804. Electrical circuity 1104 further runs from the circuit board 1008 to the LED light ring 920 to control and power the LEDs on the light ring 920.

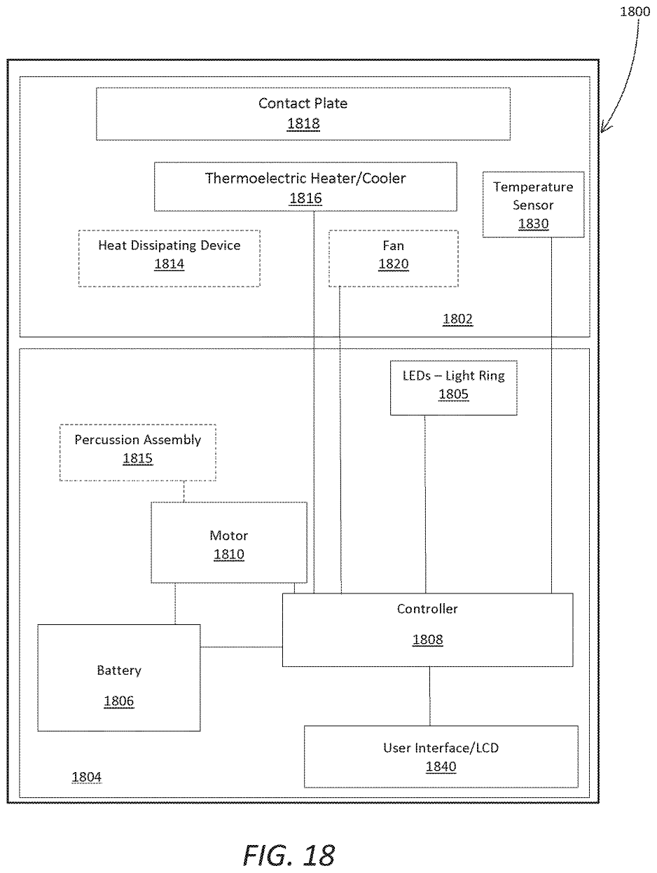

While any number of contact pins or plates 806 may be used, depending upon the application and component parts in the massage node 702, in the illustrated example, six contact plates 806 are utilized, which includes two pins for the Peltier Plate signal, two pins for the fan signal, and two for a temperature sensor, such as a thermocouple or thermistor (see FIGS. 18-20). Alternatively, three contact pins or plates 806 could also be utilized: a first plate for supplying power, a second plate for ground and a third plate for an IC signal, where a separate PCB and IC in the massage node 702 can parse the signal from the third plate.

FIG. 12 illustrates a cross-section of the portable handheld percussion massager 700 of FIG. 7, which illustrates a cross-section of the massage node 702 coupled to the massager housing 704. When coupled to the massager housing 704, the contact pins or plates 806 and 808 form an electrical connection. Again, while any number of contact pins or plates 808 may be used depending upon the application and component parts in the massage node 702, in the illustrated example, six contact plates 808 are utilized. Electrical circuits are then formed by wires 1204 connecting two of the plates 808 to the Peltier Plate 906, two of the plates 808 to the fan 910, and two of the plates 808 to a temperature sensor, such as a thermocouple or thermistor (see FIGS. 18-20). Again, as an alternative, three contact pins or plates 808 could also be utilized: a first plate to provide power, a second plate for ground and a third plate for an IC signal. By establishing this electrical connection, power is provided from the battery 1006 through the controller 1008 to the massage node 702 to control and power the Peltier plate 906, fan 910 and temperature sensor (FIGS. 18-20).

As discussed above, the massager 700 or the massage node 702 may include a light ring 105, comprised of a transparent or translucent light ring cap 918 and a circular light emitting diode (LED) ring mount 920, having at least one or a plurality of LEDs positioned about the LED ring mount 920. The light ring mount 902 is electrically connected to the printed circuit board (PCB) or controller 1008 (FIG. 10) to control the operation of the LEDs. The LEDs are then powered through the controller 1008 by battery 1006.

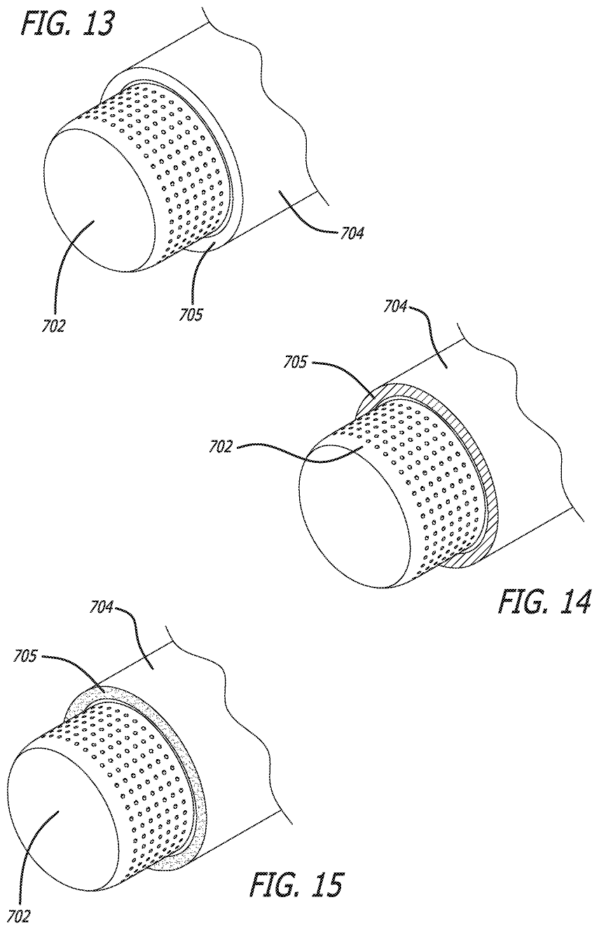

The LEDs can include single, dual or multicolor LEDs and can be activated to illuminate together or separately to display different color lights, illuminate the LEDs in a pattern, illuminate the LEDs sequentially, cause the LEDs to flash or blink and even vary the intensity of the illumination of the LEDs—all to provide many different visual illumination effects. FIGS. 13-15 illustrate, as an example, three different illumination states of the light ring 705, each providing a different illumination effect. Each differing illumination effect indicates a different state of operation of the massager 700 or the massage node 702. For purposes of this application, if the light is a solid color, this will be referred to as a “solid state” of illumination. If the LEDs illuminate in a pattern, illuminate sequentially, flash, blink or vary the intensity of the illumination of the LEDs from the prior illumination states, this state of illumination will be referred to as a “varying state.”

FIGS. 13-15 illustrated different states for the light ring 705, each state illuminating differently, corresponding to a state of operation of either or both the massager 700 or massage node 702. FIG. 13 illustrates a cut away view of massage node 702 showing the light ring in a first state. FIG. 14 illustrates a cut away view of massage node 702 showing the light ring in a second state. FIG. 15 illustrates a cut away view of massage node 702 showing the light ring in a third state. While only three states are illustrated, it is recognized the LEDs can illuminate in many more states than represented by FIG. 13-15 and the present invention is not limited to only the three illuminated states or the examples of corresponding operation providing below.

As set forth above, differing states of operation may be represented with different illuminated colored LEDs or differing LED lighting patterns, intensities, and variations. Of most benefit when used with the temperature-controlled massage node 702 may be the light ring providing different illumination states to show whether the temperature-controlled massage node 702 is operating with or without a heating and/or cooling effect. For example, the first state could represent a ready state or an off state, which represents that the massage node 702 has no heating or cooling effect activated. This illumination state could display without regard to whether the percussive massage effect is being imparted on the massage node 702. Optionally, the illumination state could illuminate, for example, as solid-state white color as a ready state for both the percussion massage effect and the heating and cooling effects when neither is engaged. When the percussion massage effect is illuminated without heating and cooling effects, the solid-state white light could change to a varying state white color to represent that percussive massage effect is engaged, but still without any heating or cooling effect.

The second state may indicate, for example, that the massage node 702 is operating in a cold state, for example, by illuminating in a solid blue. If operated with a percussive massage effect, the LEDs could change to a varying state blue color. Similarly, the third state may indicate, for example, that the massage node 702 is operating in a hot state, for example, by illuminating in a solid red. If operated with a percussive massage effect, the LEDs could change to a varying state red color.

Many different variations can be imaged to illuminate the light ring 705 and are not limited to any examples provided herein. The reference to a first, second, third state or n+1 dates, or a first, second, third or n+1 colors are interchangeable and not limited to the examples provided above. In another example, no illuminate can indicate an off state. A white colored lighted LED ring can indicate a ready state. A red colored LED ring can indicate that the massage node 702 is heated. A blue colored LED ring can indicate that the massage node 702 is cooled. The use of a varied or solid state can be based entirely on design. A varied state could indicate the node is heating up or cooling down, where the illumination becomes a solid-state illumination when the massage node reaches the desired temperature. In this example, the light ring's 705 illumination has no bearing on whether the percussive massage effect is activated.

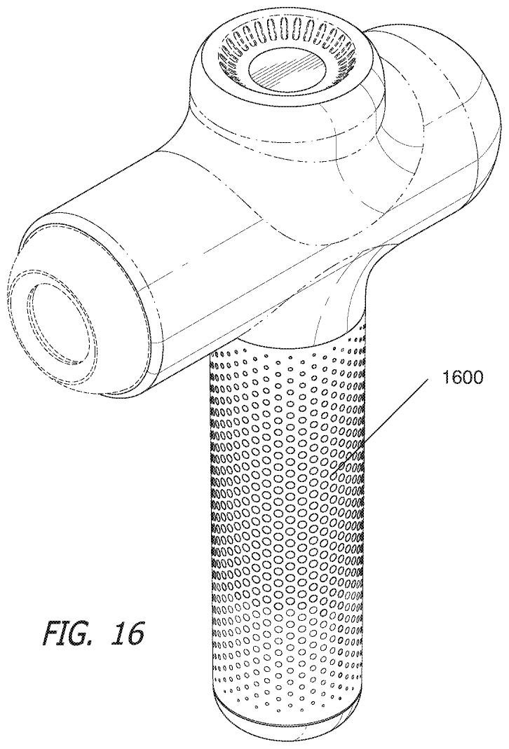

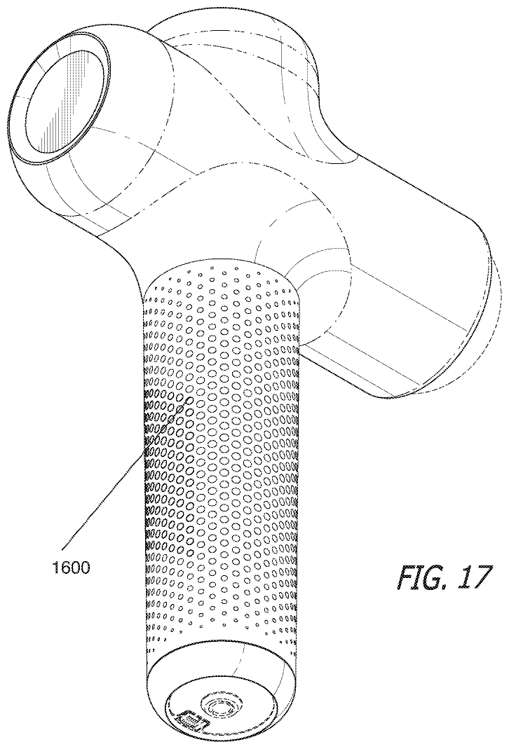

To increase friction and absorb vibration, the handle of the present invention may also include the incorporation of a sleeve that is made of a soft material, such as resilient gel, foam, silicon, rubber, a viscoelastic urethane polymer or rubber-like material. FIGS. 16 and 17 illustrate the use a rubber or silicon sleeve 1600 placed over the handle 710 to help protect the user's hand against vibration and/or slipping. The sleeve 1600 may also include grooves or pits to create further friction and cushioning, increasing griping ability and add air pockets to help absorb vibration. The use of both padding and air pockets can together help absorb vibration. An array of air pockets may also be included in the handle to help absorb vibration.

As described above, the temperature-controlled massage node 102, 702 of the present invention, can be affixed to a massager housing 104 or can be removable coupled to a massager housing 702. Further, many of the component parts found in the massager 100, 700, such as the battery and controller can be integrated into the massage node 102, 702 so that the massage node 102, 702 can operate independent of its connection with a massager 100, 700, especially when removably coupled. By operating independent of the massager 700, the massage node 702 can be removable coupled to other component parts, such as a handle or charger, or may be simply affixed to a handle (having little or no internal parts) for ease of use of the massage node 702 as its own self-contained massager.

FIG. 18 is a block diagram of one example of an implementation of a portable handheld massager 1800 of the present invention having the node affixed to the massager body. Here, the portable handheld massager 1800 includes both a massager housing 1804 and a massage node 1802. The massager housing 1804 includes a battery 1806, a controller 1808, a motor 1810 and a percussion massage assembly 1815. The percussion massage assembly 1815 may include a crankshaft, rod and piston for imparting percussive massage effect on the massage node 1802. Alternative, the motor 1810 may be a vibrating motor and the portable handheld massager 1800 may provide a vibrating effect on the user or the massager housing 1804 may separately include a vibrating motor in addition to the motor 1810 and percussion assembly 1815 to provide both a vibrating and/or percussive massage effect. The massager housing 1804 further includes a user control interface 1840 to allow the user to control the operation of the massager, which may include an LCD display. Optionally, the massager housing 1804 may further include a light ring or LEDs 1805 that illuminate to indicate certain operational modes of the massager 1800 or massage node 1802, as described above.

Here, the massage node 1802 includes at least one heater and/or cooler 1816, such as a Peltier plate. The massage node 1802 further includes a contact medium 1818 and temperature sensor 1830, such as a thermocouple or thermistor. The massage node 1802 may further include either or both a heat dissipating device 1814 and a fan 1820. As discussed above, the heat dissipating device 1814 may be a heat sink or the heat dissipating device 1814 form part of the node housing.

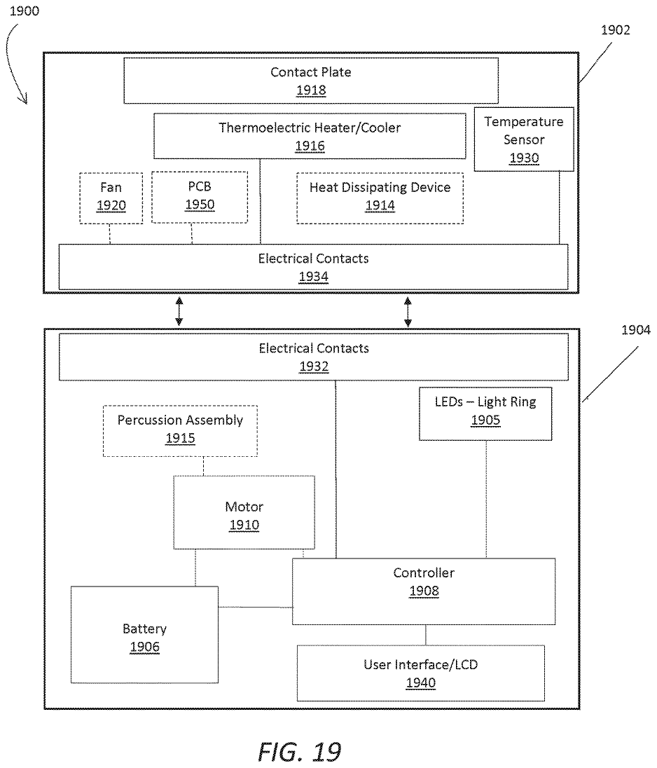

FIG. 19 is a block diagram of one example of an implementation of a portable handheld percussion massager 1900 of the present invention having the node 1902 removably coupled to the massager housing or body 1904. Here, the portable handheld massager 1900 includes both a massager housing 1904 and a massage node 1902; however, the massage node 1902 is removably coupled or attached to the massager housing 1904. Both the massager housing 1904 and massage node 1902 including electrical contacts 1934 and 1932 that make electrical contact with one another when the massage node 1902 is attached to the massager housing 1904. When the massage node 1902 is coupled to the massager housing 1904, the electrical contacts are aligned with one another, in contact with one another and/or paired with one another (when applicable) to couple the electrical contacts.

Like with the massager in FIG. 18, the massager housing 1904 includes a battery 1906, a controller 1908, a motor 1910 and a percussion massage assembly 1915. The percussion massage assembly 1915 may include a crankshaft, rod and piston for imparting percussive massage effect on the massage node 1902. Alternatively, the motor 1910 may be a vibrating motor and the massager housing 1904 may provide a vibrating effect on the user or, the massager housing 1904 may separately include a vibrating motor in addition to the motor 1910 and percussion assembly 1815 to provide both a vibrating and/or percussive massage effect. The massager housing 1904 further includes a user control interface 1940, which may include an LCD display. The massager housing 1904 may further include a light ring or LEDs 1905 that illuminates to indicate certain operational modes of the massager 1900 or massage node 1902, as described above.

Again, like in FIG. 18, the massage node 1902 includes at least one heater and/or cooler 1916, contact medium 1918 and temperature sensor 1930. The massage node 1802 may further include either or both a heat dissipating device 1914 and a fan 1920, where the heat dissipating device 1814 may be a heat sink or may be incorporated into the node housing. The massage node 1902 may also includes a separate PCB/controller or IC 1950 to assist with parsing signal information, which can help reduce the required number of electrical contacts 1932 and 1934.

In the examples provided in FIGS. 18 and 19, the motor 1810, 1910, and percussion massage assembly 1815, 1915 may be used with, or either replaced by, a vibrating motor to allow the massager 1800, 1900 to impart a vibrating massage effect on massage node 1802, 1902 (and thus the user), in addition to or in lieu of the percussive massage effect. The LED light ring 1805, 1905 may be incorporated into the massage node 1802, 1902 rather than on the massager housing 1804, 1904.

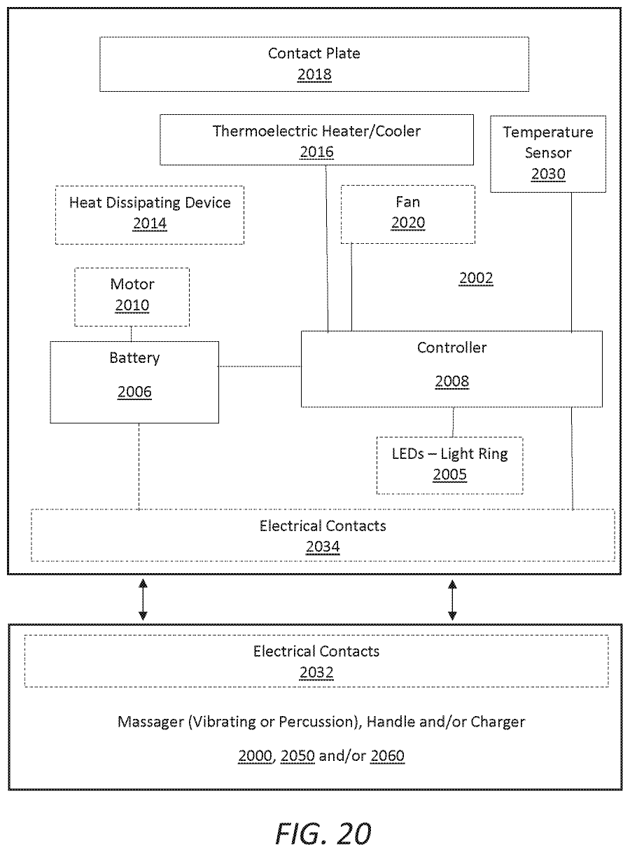

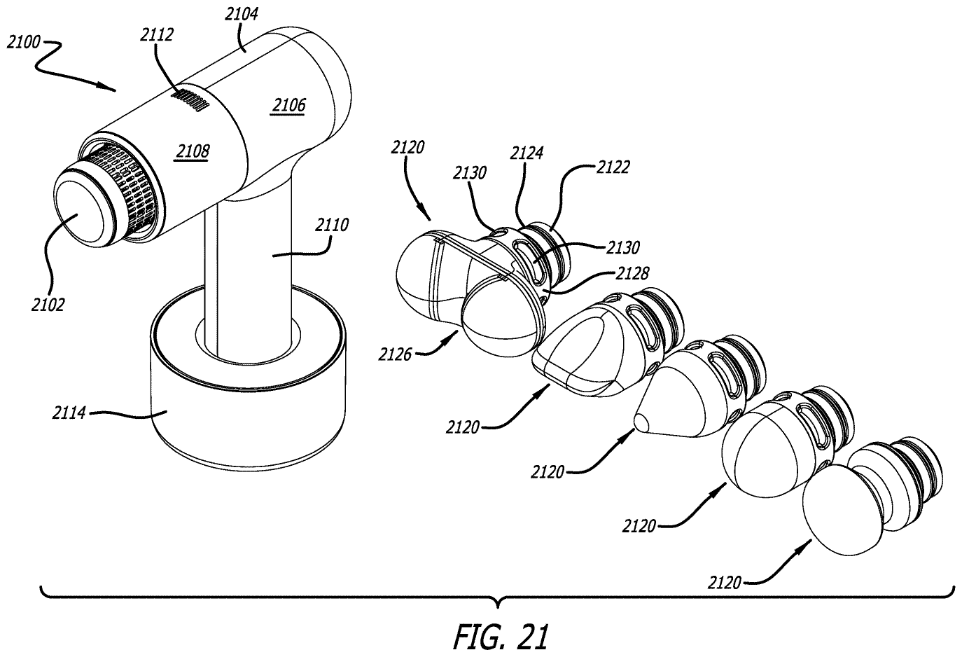

FIG. 20 is a block diagram of one example of an implementation of a portable handheld percussion massager of the present invention having an intelligent massage node 2002 in that the massage node 2002 includes its own controller 2008 and battery 2006. As illustrated, in this example, the massage node 2002 includes its own battery 2006, controller 2008, thermoelectric heater/cooler 2016, temperature senser 2030 and contact medium 2018. The massage node 2002 may further include either of both a heat dissipating device 2014 or a fan 2020. A light ring 2005 may further be incorporated into the massage node 2002. The massage node 2002 may even include a vibrating motor 2010 to vibrate the massage node 2002.

The massage node 2002 may be affixed or attached to a handle 2050 for use, which may be a dummy handle, or may incorporate some or parts in the massage node 2002, like a separate battery and/or vibrating motor 2006. The massage node 2002 may also attached to a massager for imparting, for example, a percussion or vibrating massage effect on the massage node 2002. User controls may be built into the node or may be controlled wirelessly, in which case the massage node can include a transceiver or Bluetooth capabilities. The massage node 2002 may further include electrical contacts for communicating with a massager (either percussion or vibrating) or a handle, which may also include user controllers, or even with a charger for recharging the battery 2006 or powering the massage node 2002. The intelligent massage node 2002 can also be designed as a unitary handheld device.

FIG. 21 illustrates a side perspective view of yet another example implementation of a portable handheld percussion massager 2100 of the present invention. As illustrated in FIG. 21, the portable percussion massager 2100 includes a massager housing 2104 having a main body 2106, forward body 2108 and a handle 2110. In this example, the handle 2110 may be formed extending downward from the main body 2106, which in this example is positioned generally perpendicular to the main body 2106. The main body 2106, forward body 2108 and a handle 2110 may be constructed from one or more pieces to form a hollow massager housing 2104. For example, the main body 2106 and the handle 2110 may be constructed from at least two separate pieces-a right side piece and a left side piece that engage one another to form a hollow massager housing 2104. As set forth above, these examples are not limiting. The massager housing 2104 may be made from any number of different pieces formed together or separately. Further, although FIG. 21 shows the main body 2106 formed from a left and right side piece and a back panel, the left and right side piece and back panel may be covered in a foam, plastic, neoprene, or other similar type of material to help absorb noise generated from the percussion massager 2100. Additionally, in this example, vents 2112 may be included on the massager housing 2104 to help dissipate heat generated by the percussion massager 2100. Here, the vents 2112 are positioned on the top side of the forward body 2108.

As in prior examples, the percussion massager 2100 includes a power source, which in this case, is a rechargeable battery located in the handle 2110 of the percussion massager 2100. In this example, the battery may be charged by inserting the handle into a charging cradle 2114. In this manner, either contact or contactless charging may be utilized to charge the battery.

In this example, like the example described above in connection with FIG. 7-15, the massage node 2102 is removable. In addition to the massage node 2102, dummy massage nodes 2120 may also be designed to couple to the percussion massager 2100. The dummy massage nodes 2120 include a node connector 2122 having a series of ridges and grooves that couple with corresponding ridges and grooves in the percussion massager 2100 to connect the dummy massage nodes 2120 to the percussion massager 2100 via a friction fit. The dummy massage nodes 2120 include node heads 2126, each of a different design to impart a different massage effect on a user. The dummy massage nodes 2120 also each include spacers 2128 positioned between the node connectors 2122 and node heads 2126. The spacers 2128 may include openings 2130 to reduce the overall weight of the dummy massage nodes 2126.

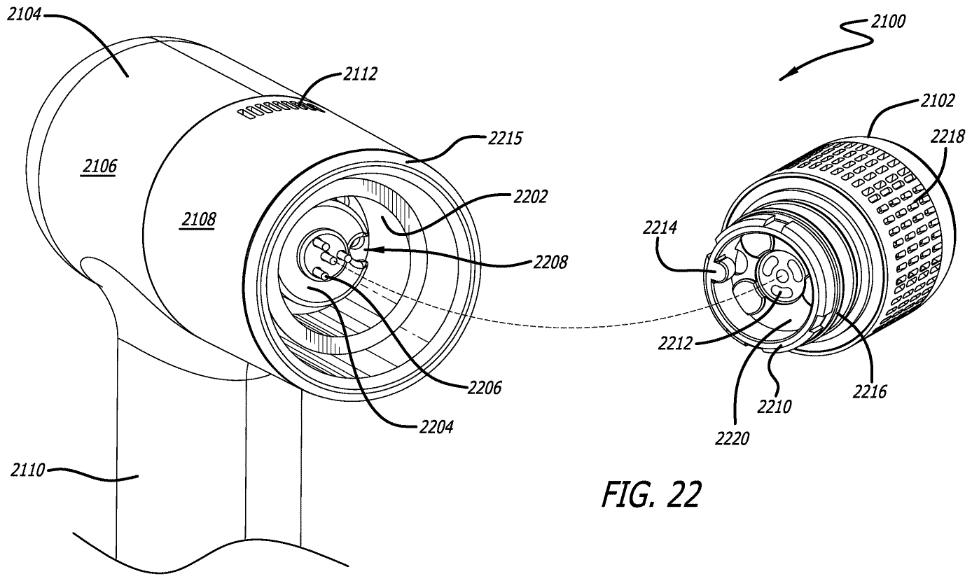

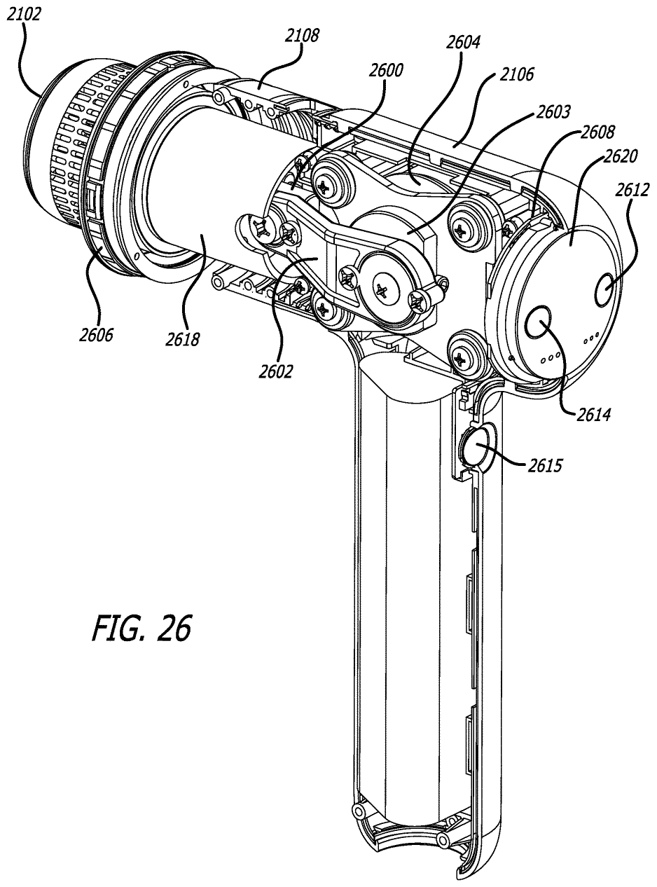

FIG. 22 illustrates a side perspective view of the portable handheld percussion massager of FIG. 21 with the massage node removed. Here, the massage node 2102 is removably coupled to a node mount 2202 that is driven by the massage piston 2600 (FIG. 26). In this example, the massage node 2102 includes a node connector 2210 that is attached to the node mount 2202 of the percussion massager 2100 though a friction fit or press fit created by raised ribs 2216 on the mounting member of the massage node 2102 for insertion into the node mount 2202. This creates a friction, interference, or transition type fit. As before, other known mechanisms for coupling the massage node 2102 to the node mount 2202 may be provided, including but not limited to, for example, threading.

Additionally, the massage node 2102 in the present example includes a locking tab 2214 for locking the massage node 2102 into the node mount 2202 once inserted in the node mount 2202, as will be explained further below.

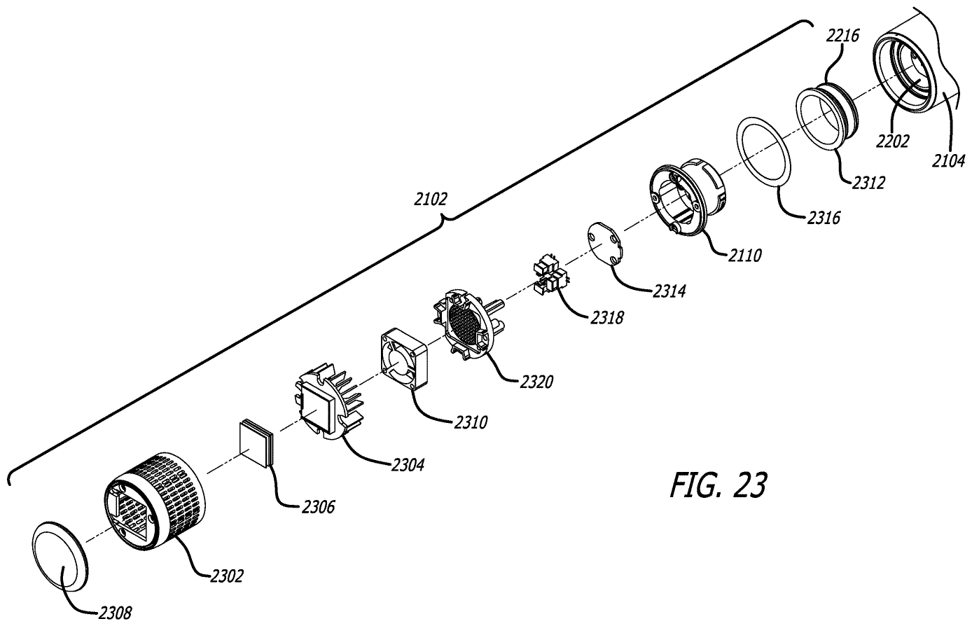

As illustrated, the node mount 2202 is a generally cupped shaped structure having a raised central mating pad 2204 that includes at least one electrical contact pin, plate or leaf spring plate for making contact with at least one corresponding electrical contact pin, plate or leaf spring plate on the massage node 2102. Here, the mating pad 2204 of the node mount 2202 includes four spring loaded pins 2206 for contacting plates 2212 on the massage node 2102. In other examples, six or more spring loaded pins 2206 may be used. The corresponding electrical contacts 2212 on the massage node 2102 are in communication with a thermoelectric heating and cooling device 2306 (FIG. 23) or Peltier plate and fan 2304 (FIG. 23). Power is supplied to thermoelectric heating and cooling device 2306 and fan 2304 when the temperature-controlled massage node 2102 is coupled to the node mount 2202.

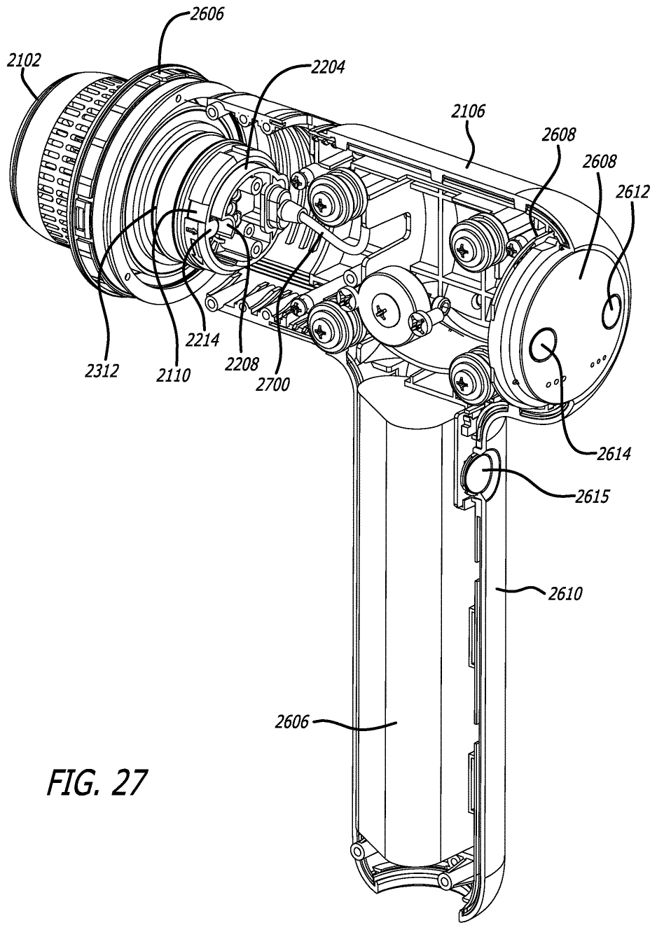

In this example, the mating pad 2204 of the node mount 2202 further includes a locking mechanism to prevent the massage node 2102 from disengaging with the massager 2100 during operation due to the weight of the massage node 2102. While many mechanical mechanisms are known locking two parts, in this example, a notch 2208 is provided for aligning with tab 2214 on the node connector 2210 of the massage node 2102 when the massage node 2102 is inserted into the massager housing 2104. The notch 2208 allows the tab 2214 to pass through the notch 2208 such that it is positioned under the top surface of the mating pad 2204 when the massage node 2102 is inserted into the node mount 2202. As will be explained further in connection with FIG. 27, the mating pad 2204 of the node mount 2202 includes an open area on its side directly adjacent to the notch 2208 and underneath the top surface of the mating pad 2204 to allow the tab 2214 to be positioned underneath the top surface of the mating pad 2204 and away from the notch 2208 upon the rotation of massage node 2102 once the node connector 2210 of the massage node 2102 is inserted into the node connector 2210 of the massage housing 2104. This rotation of the massage node 2102 and position of the tap 2214 under the top surface of the mating pad 2204 locks the massage node 2102 in place against the node mount 2202. Since the electrical contacts are spring loaded pins 2206 and plates 2212, the pins 2206 are still able to maintain contact with the plates 2212 upon rotation of the massage node 2102 to lock the massage node 2102 in place against the node mount 2202 of the percussion massager 2100. As set forth above, the electrical contacts 2206 and 2212 may be any one or combination of electrical contact pins, plates, leaf spring plates or rings. The placement of the pins 2206 and plates 2212 may also be reversed.

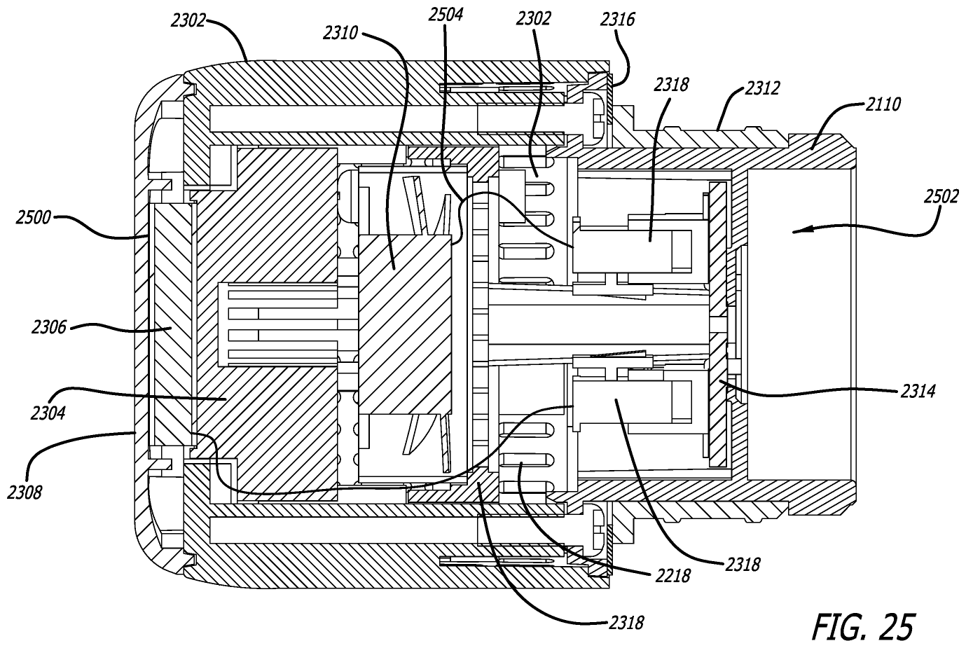

FIG. 23 illustrates an exploded view of the massage node 2102 of FIG. 22 separated from the massage housing 2104. Temperature-controlled massage node 2102 includes a node housing 2302, a heat dissipating or absorption device 2304, and at least one thermoelectric heater/cooler 2306, often referred to as a Peltier plate or chip, and a contact medium or thermal conductive plate 2308 for covering the Peltier plate 2306 to help dissipate the heating and cooling effect of the Peltier plate 2306 and transfer the heating or cooling effect to the user. As before, the heat dissipating or absorption device 2304 may be, as illustrated, a heat sink, which in this example may be made of metal. The contact medium 2308 may be, for example, be an aluminum or stainless teel plate (or other thermal conductive metal) and may be formed as part of the node housing 2302 or be a separate piece from the node housing 2302. As with the prior example in FIGS. 7-12, a softer material may be used in connection with the contact medium 2308 or in place of the contact medium/thermal conductive plate 2308, such as a thermal conductive cloth like pad or material, which may be made, for example, from cloth, plastic, graphite, carbon fiber and/or a silicon material (such as a gel or resin) having conductive fibers, to name a few examples. A thermal conductive paste 2500 (FIG. 25) may also be used between the thermal conductive plate 2308 and the thermoelectric heater/cooler 2306.

Here, the temperature-controlled massage node 2102 further includes a fan 2310 for active cooling. The fan 2310 is positioned underneath the heat sink 2304 and is in communication with the electrical contact pins and/or plates 2212 to power the fan 2310 when the node 2102 is coupled to the massager housing 2104.

To couple the massage node 2102 to the housing 2104, the massage node 2102 includes at least one node connector 2110, which may be a mounting sleeve or shaft for coupling the massage node 2102 to the massager body or housing 2104. In this example, the mounting sleeve 2110 further includes an outer sleeve 2312 and sealing ring 2316 positioned between the mounting sleeve 2110 and outer sleeve 2312. The outer sleeve 2312 includes raised ribs or ridges 2216 for creating a friction fit against an interior surface of the massage node mount 2202, or optionally, interlocking with corresponding grooves on the interior of the massage node mount 2202 for creating a friction fit between the massage node 2102 and massager housing 2104, when the massage node 2102 is inserted in the massage node mount 2202 of the massager housing 2104.

The node connector 2110 includes a recessed plate 2220 creating a recessed area within the node connector 2110 for receiving the mating pad 2204 of the node mount 2202. The recessed plate 2220 includes, in this example, electrical contact plates 2212 for making contact with the spring loaded pins 2206 of the mating pad 2204. Also included in the massage node 2102 of this example is a PCB or controller 2314 and electrical contact leads 2318. The massage node 2102 further includes a bridge housing or middle support member 2320 for securing the contact leads 2318, PCB 2314 and node connector 2110 with sealing ring 2316 and mounting sleeve 2312 to one side of the support. The bridge housing 2320 supports the fan 2310, heat sink 2304 and Peltier plate 2306 at its opposing side.

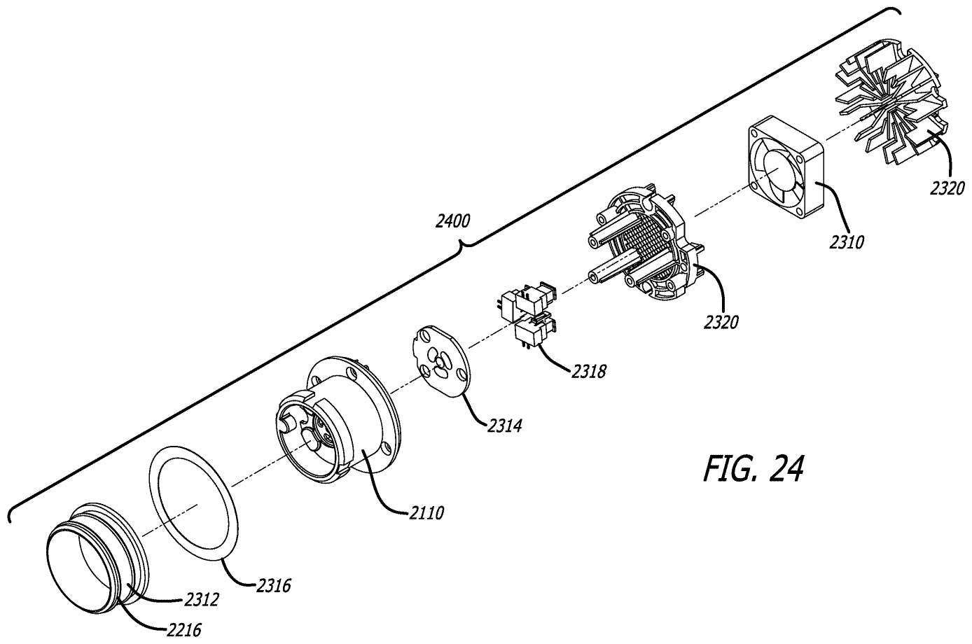

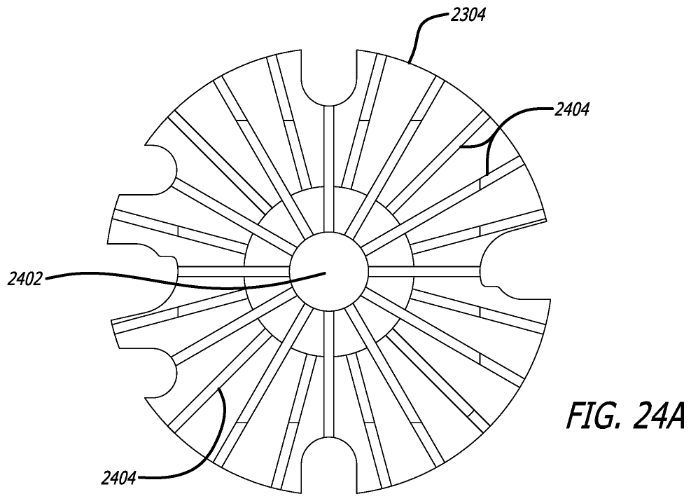

FIG. 24 illustrates an opposing exploded view of a portion of the massage node of FIG. 23. Here, the screw mounts on the bridge housing 2320 for securing the PCB board and electrical connectors 2318 against the underside of the node connector 2110. This view also illustrates the radiating vanes 2404 (FIG. 24A) of the heat sink 2304, as further described in connection with FIG. 24A.

FIG. 24A is a bottom view of the heat sink 2304 of FIG. 24. The heat sink 2304 used in this example includes vanes 2404 that radiate about an opening 2402 in the middle of the heat sink 2304 to create a generally symmetrically shaped heat sink that permit air flow about the entire periphery of the massage node 2102. This use of this heat sink 2304 design in a cylindrical shaped massage node 2102 maximizes airflow and cooling effect. Further, the massage node 2102 housing includes perforations or vents 2218 (FIG. 22) about the peripheral sides of the massage node 2102 to further maximize airflow and cooling.

FIG. 25 is a cross-section of the massage node 2102 shown in FIG. 22. As shown in FIG. 25, the massage node 2102 includes a node connector 2110 having a recessed area 2502 for receiving the mating pad 2204 of the node mount 2202 of the massager 2100. An outer mounting sleeve 2312 is positioned around the node connector 2110 having raised ribs for creating a friction fit with the interior walls of the node mount 2202. The sealing ring 2316 can be seen between the outer mounting sleeve 2312 and node connector 2110. The PCB 2314 and electronic connectors 2318 are positioned within the walls of the node connector 2110 opposite the recessed area 2502 behind the recessed plate 2220, secured against the node connector 2110 by bridge housing 2320. The relative placement of the fan 2310, heat sink 2304, Peltier plate 2306, contact medium 2308 and the node housing 2302 with vent openings 2218 are also best seen in FIG. 25. Electrical wires 2504 and 2506 can also be seen running from the electronical connectors to the fan 2310 and Peltier plate 2306 respectively.

A thermal conductor 2500, such as a thermal paste, may be positioned between the Peltier plate 2306 and the contact medium 2308 to transfer heat and/or cold between the Peltier plate 2306 and the contact medium 2308. The Peltier plate 2306 may be, for example, a single Peltier chip with reverse polarity for heating and cooling. While the illustrated examples show the use of only one single Peltier plate or chip 2306, more than one plate or chip may also be utilized in different configurations, such as by stacking the chips or positioning the chips side-by-side.

FIG. 26 illustrates a side perspective view of the portable handheld percussion massager of FIG. 21 with the side panel of the massager housing 2104 removed. As shown, the portable handheld percussion massager 2100 includes the piston 2600, rod 2602, crankshaft 2603 and motor 2604, which imparts a percussion massage effect on the node mount 2202. The rear exterior walls 2618 of the node mount 2202 can be illustrated in FIG. 26, which forms the exterior cup like structure of the node mount 2202. The piston 2600 is coupled to the node mount 2202 behind the mating pad 2204, which then couples to the massage node 2102. The motor 2604 rotatably drives a crankshaft 2603 which is coupled to the piston 2600 by rod 2602 to create a percussive massage effect by moving the node mount 2202 and coupled massage node 2102.

As with the prior examples, a battery 2606 and circuit board/controller 2608 are also provided to control the operation of the massager 2100. All the same optional power sources that were discussed in connection with the prior examples are applicable to this example massager 2100, including the option of the massage node 2102 having its own independent power source to control its operation from hot to cold, and or even to provide a vibrating massage effect in addition to, in combination with, or absent any percussive massage effect. Here, by including a printed circuit board 2134 in the massage node 2102, the massage node 2102 can control the amount of current passed to the Peltier plate 2306 and control the temperature of the massage node 2102 in response to a thermal sensor positioned in the node 2102, which may also be powered through an electrical connector 2318.

Further, in the illustrated example, controls 2612, 2614 and 2615 may be positioned on the massager housing 2104, with, for example, a liquid crystal display. As with other examples, the user may turn the percussion massager 2100 on and off using user control 2615 or may also use other separate controls (not shown). The user can also use controls 2612 and/or 2614 to control the various speeds of the motor 2604, to create different percussion massage effects and further control the hot and cold effects imparted by the temperature-controlled massage node 2102 when the heating and cooling effects are engaged.

As shown in connection with FIG. 22, a light ring 2215, similar to that in design and operation as previously described above, may also be provided on the massager housing 2104 to communicate the state of the operation of the percussion massager 2100 and/or the massage node 2102 to the user. The LED ring 2616 used in connection with the light ring 2215 is further illustrated in FIG. 26. Here, the LED ring 2616 is shown such that the LEDS are positioned at the end of the front housing 2106 and illuminate from the sides of the housing outward. Alternatively, as described above, the LED ring 2616 can be positioned on the end of the front housing 2106 to shine directly outward toward the massage node 2102.

FIG. 27 illustrates a side perspective view of the portable handheld percussion massager 2100 of FIG. 21 and illustrates all the same parts as shown in connection with FIG. 26 except that parts that impart the percussive massage effect have been removed (i.e., the piston 2600, rod 2602, crankshaft 2603 and motor 2604) and the exterior side walls 2618 of node mount 2202 have been removed to better illustrate the coupling of the mating pad 2204 of the node mount 2202 to the node connector 2110 of the massage node 2102. It can further be seen that power is provided to the electrical contact pins 2206 on the mating pad 2204.

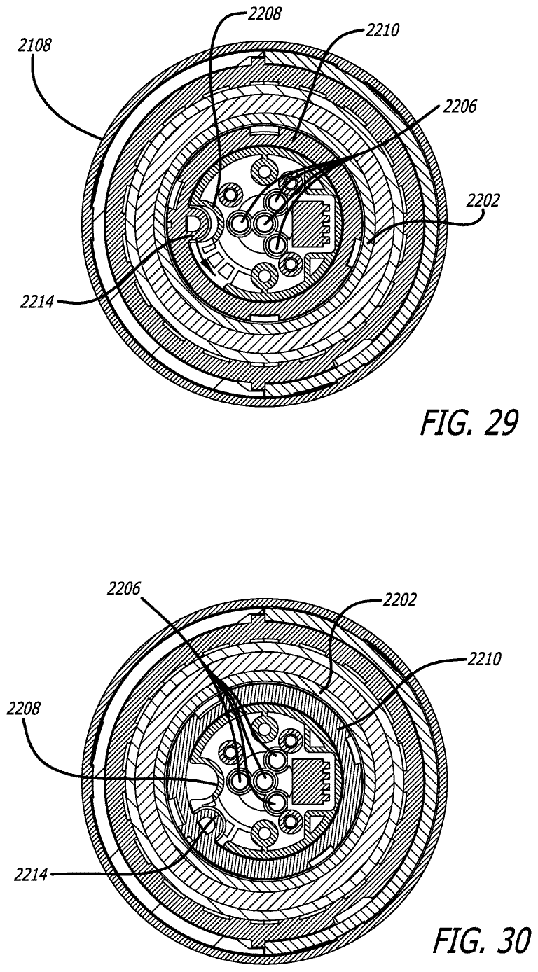

The positioning of the tab 2214 through the notch 2208 to be under the top surface of the mating pad 2204 can also be seen in this view, as well as the open side space that allows for the rotation and movement of the tab 2214 under the top surface of the mating pad 2204, as also shown and described below in connection with FIGS. 29 and 30. As illustrated in FIGS. 26 & 27, the positioning of the battery 2606 is entirely within the handle 2610 and also under the motor 2604.

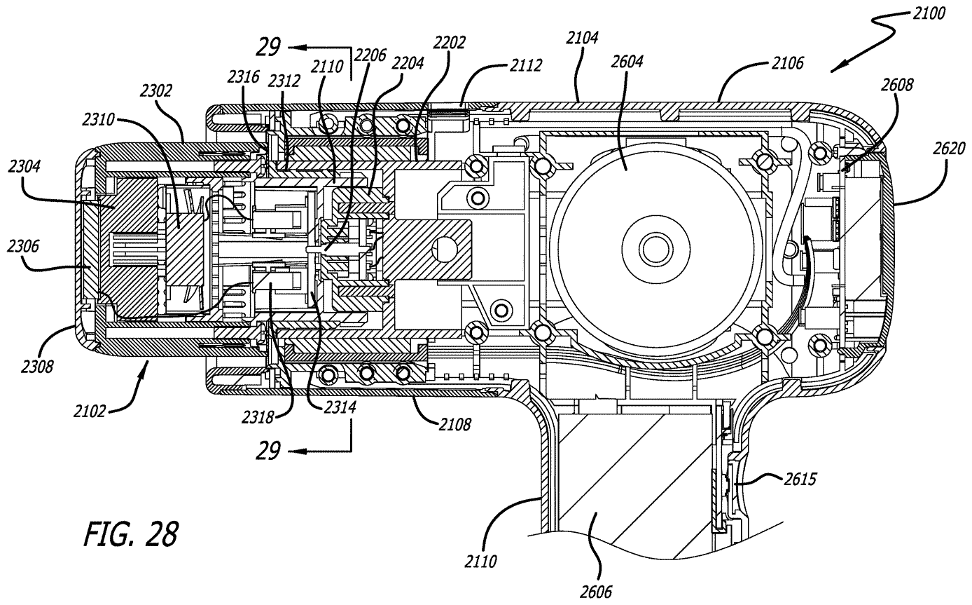

FIG. 28 illustrates a cross-section of the portable handheld percussion massager 2100 of FIG. 21 with the massage node 2102 attached, and thus also illustrates a cross-section of the massage node 2102 coupled to the massager housing 2104. When coupled to the massager housing 2104, the contact pins 2206 form an electrical connection with the contact plates 2212 on the massage node 2102. Again, while any number of contact pins or plates may be used depending upon the application and component parts in the massage node, in the illustrated example, four contact pins 2206 and plates 2212 are utilized, one providing power to the integrated circuit/printed circuit board/controller 2314 of the massage node 2102. Electrical circuits are then formed by wires 2504 and 2506 (FIG. 25) to the Peltier Plate 2306 and the fan 2310 and a temperature sensor, such as a thermocouple or thermistor (see FIGS. 18-20), which may be similar included in this example. In this example, by using a temperature sensor and a controller 2314, circuitry with the massage node 2102 can control the operation of the massage node 2102 and control the heating and cooling of the node in response to both the temperature sensor and signals from the controller 2608.

As discussed above, the massager 2100 or the massage node 2102 may include a light ring 2215, comprised of a transparent or translucent light ring cap and a circular light emitting diode (LED) ring mount 2616 having at least one or a plurality of LEDs positioned about the LED ring mount 2616. The light ring mount 2215 is electrically connected to the printed circuit board (PCB) or controller 2608 to control the operation of the LEDs. The LEDs are then powered through the controller 2808 by battery 2606.

FIG. 29 illustrates a cross-section of the portable handheld percussion massager with massage node taken along line 29-29 of FIG. 28, showing the massage node in an unlocked position. Here, the tab 2214 is aligned with the notch 2208 for insertion of the node connector 2210 into the node mount 2202 and the space along the side wall of the mating pad 2204 of the node mount 2202 that allows for the rotation and locking of the massage node 2102 against the node mount 2202.

FIG. 30 illustrates a cross-section of the portable handheld percussion massager with massage node taken along line 29-29 of FIG. 28, showing the massage node in a locked position. Here, the tab 2214 is offset from the notch 2208 after rotation of the massage node 2102 in the direction shown in FIG. 29, thereby locking the locking of the massage node 2102 against the node mount 2202.

In all the above examples, the power supply is shown as a battery; however, the use of a battery, although preferred, is optional. The power supply may come from either or both a battery or an electrical outlet, such that the power supply or electricity can be drawn from either or both the battery or an electrical outlet by plugging the massager housing, handle or massage node into an electrical outlet. Plugging into an outlet may also serve to charge the internal battery and/or provide power to the device.

Further, while any number of contact pins or plates may be used, depending upon the application and component parts in the massage node, in one example, six contact plates are utilized, which includes two pins for the Peltier Plate signal, two pins for the fan signal, and two for a temperature sensor, such as a thermocouple or thermistor (see FIGS. 18-20). Alternatively, four contact pins or plates could also be utilized where a separate PCB and IC are in the massage node to parse the signal from one or more of the plates.

In operation, in any of the examples described above, the massager controls include either or both heat and/or cooling effect options. When activated, a voltage is applied across joined conductors on at least one thermoelectric heater/cooler (e.g., Peltier plate) to create an electric current. When the current flows through the junctions of the two conductors, heat is removed at one junction and surface cooling occurs. At the other junction surface, heat is deposited. In other words, a first side of the plate is cooled while the second side is heated. When the current flow is reversed, the first side of the plate is heated while the second side is cooled, allowing for the Peltier plate to provide both heating and cooling effects on a first side of the plate, which effects can then be transferred to the user. The amount of voltage supplied to the Peltier plate will dictate how hot or cold the plate will be become. In certain embodiments, one temperate for both hot and cold effects can be provided, whereas in other examples, the user may select between different temperature modes (e.g., high, low and medium) and the massager can be programmed to provide different voltages to the Peltier plate in response to the user selection, thereby causing varying temperatures in the Peltier plate based upon user selection. In some examples, single, dual or triple settings for both hot and cold can be provided to a user that correspond to preset temperatures and/or supplied voltage amounts to the Peltier plate.

The massager may also include temperature sensors, which may, for example, be a thermocouple or thermistor (NTC thermistor) to regulate the amount of heat or cold effects produced by the Peltier plate. The temperature sensor is be positioned near the thermoelectric heater/cooler to sense the temperature of the massage node near the thermoelectric heater/cooler. If the thermoelectric heater/cooler (e.g., Peltier plate) become too hot, the controller can reverse the current to cool down the plate. Further, an auto-reverse to the polarity may be used to “normalize” the temperature quickly when shutting off the heat or cold so that the node does not retain unwanted temperature. The controller may also include an auto-shut off if the Peltier plate is left on for a predetermined period, or if it reaches a certain temperature. The controller can also control the time and direction in which current is applied to the thermoelectric heater/cooler and can flip between hot and cold setting to maintain a certain predetermined or user selected temperature in response to the temperatures sensed by the temperature sensor.

In some implementations, the temperature-controlled massage node is heated or cooled to a predetermined temperature upon activation of the Peltier plate to heat or cool the node. Once activated or upon activation, in certain implementations, the user can heat and cool the Peltier plate to predetermined temperatures, for example, at least two predetermined temperatures, or in some examples, at least three predetermined temperatures, may be selected by the user.

FIGS. 31-37 illustrate additional examples of a handheld percussive massager of the present invention that incorporates a safety mechanism preventing activation or continued operation of the massaging device unless a massage node is properly and securely attached to its reciprocating piston. It should be understood that all features and functions incorporated in the percussion massagers described in FIGS. 1-30 above may also be incorporated in the percussion massagers described in FIGS. 31-37 below. Similarly, all features and functions incorporated in the percussion massagers described in FIGS. 31-37 below, namely the safety mechanism, may also be incorporated in the percussion massagers described in FIGS. 1-30 above. Accordingly, any massage node described in connection with FIGS. 1-30, including temperature-controlled massage nodes and intelligent massage nodes having its own controller and power source, may be used with the safety mechanism embodiments described in FIGS. 31-37, and the safety mechanism may be retrofitted or integrated into any of the percussion massagers and massage node mounting systems described in connection with FIGS. 1-30.

FIGS. 31-37 illustrate a percussion massager designed to address safety concerns found in conventional percussion massagers, particularly the risk of unintentional user injury caused by an exposed and moving piston or accidental activation during massage node interchange. In conventional percussion massagers, the piston reciprocates at high frequencies, typically in the range of at least approximately 1,000 to 3,500 percussions per minute, and with substantial force. When a massage node is absent or improperly attached, the exposed distal end of the rapidly reciprocating piston presents a direct hazard to the user. The piston may strike, pinch, or abrade exposed skin, particularly the user's fingers, which are in close proximity to the piston opening during massage node interchange. Furthermore, in certain configurations, the distal end of the piston may include mounting hardware such as threads, pins, or protrusions that can exacerbate the risk of injury upon contact with skin.

The safety mechanisms described herein address these hazards by establishing a condition to motor activation: the massage node must be properly and securely attached to the piston for motor activation. This condition is enforced through one or more safety mechanisms that will prevent the motor from activating and/or will halt motor activation if the massage node is not properly and securely attached to the piston. In particular, if the massage node becomes dislodged, loosened, or otherwise improperly positioned during operation, the safety mechanism immediately disables the motor to halt piston reciprocation. This safety mechanism is particularly advantageous in multi-node percussion massagers where users may frequently change massage attachments or massage nodes or where non-expert handling may occur, thereby necessitating safeguards.

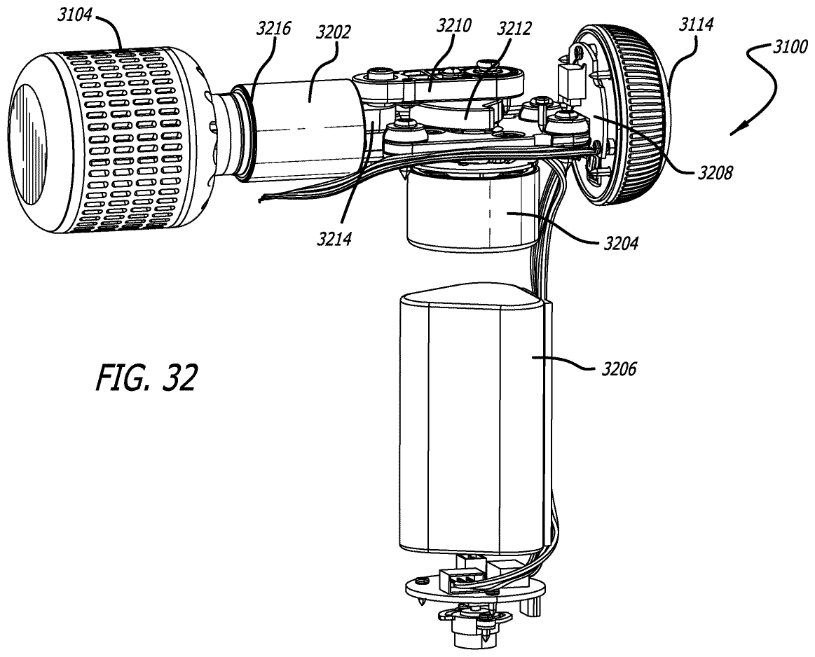

FIG. 31 illustrates a side perspective view of one example implementation of a portable handheld percussion massager 3100 of the present invention. In general, percussion massager 3100 comprises a massager housing 3102 and a massage node 3104 removably attached to massager housing 3102. Multiple interchangeable massage nodes, including temperature-controlled or intelligent massage nodes 3104 and/or non-temperature controlled or non-intelligent massage nodes 3106, may be incorporated or attached to percussion massager 3100 as shown in FIG. 31. Massage nodes 3104, 3106 are detachable accessories that transfer percussive force from the piston 3202 (see FIG. 32) to the user's body. As shown in FIG. 31, massage nodes 3104, 3106 may vary in shape, size, durometer, or functional purpose (e.g., a temperature-controlled massage node or independently powered massage node as described in FIGS. 1-30 above). Each massage node 3104, 3106 includes one or more components that interact with corresponding components on the piston 3202 when the massage node is attached to the piston 3202 to establish the safety interlock described herein.

The massager housing 3102 defines the external structural envelope of the percussion massager 3100 and may be constructed from one or more pieces of injection-molded plastic, composite material, metal, or any combination thereof. In certain embodiments, the massager housing 3102 comprises a main body portion 3108, a forward housing portion 3110, and a handle portion 3112 having a hollow interior that houses a battery or power source 3206 (see FIG. 32). The massager housing 3102 may further include a rear panel or end cap 3114 that includes a user control interface. The handle 3112 may extend downwardly from the main body 3108 at an angle (e.g., perpendicular) optimized for ergonomic grip during use, and may include a soft-grip sleeve made of resilient gel, foam, silicone, rubber, or a viscoelastic urethane polymer to increase friction, absorb vibration, and improve user comfort.

The massager housing 3102 may further include vents or perforations disposed on the main body portion 3108 or forward housing portion 3110 to facilitate airflow and dissipate heat generated by the motor 3204 (see FIG. 32) and other internal components during operation. In certain embodiments, the exterior surfaces of the massager housing 3102 may be partially or fully covered in a noise-dampening material such as foam, neoprene, or rubber to reduce operational noise transmitted to the user.

FIG. 32 illustrates a side perspective view of percussion massager 3100 with the massager housing 3102 removed. As shown in FIG. 32, massager 3100 comprises a piston 3202, an electric motor 3204 in communication with a motor power delivery circuit (i.e., an electrical power path or electrical circuit between the power source and the motor which includes an electrical pathway through which power travels from a source to the motor), a power source 3206 (typically one or more rechargeable batteries), and a controller/printed circuit board (PCB) 3208 having an integrated microcontroller unit (MCU) or application-specific integrated circuit (ASIC) responsible for device control logic.

The piston 3202 is a reciprocating component configured to be in operative communication with motor 3204 and move in a substantially linear direction along a reciprocation axis parallel to the longitudinal axis of the main body 3108 of the massager housing 3102. The piston 3202 includes a proximal end 3214 and distal end 3216. The proximal end 3214 is mechanically coupled to the output shaft of the electric motor 3204 via a connecting rod 3210 and crankshaft or cam 3212. The distal end 3216 extends toward an aperture at the forward housing 3110. The distal end 3216 of the piston 3202 interfaces with, couples, and/or receives interchangeable massage nodes 3104, 3106.

In the illustrated embodiment, the proximal end 3214 of the piston 3202 is mechanically coupled to motor 3204 through a percussion massage assembly that converts the rotational output of the motor 3204 into linear reciprocating motion. The percussion massage assembly may comprise a crankshaft or cam 3212 rotatably driven by a motor shaft, and a connecting rod 3210 having a first end coupled to the crankshaft 3212 at a point offset from the rotational axis of the crankshaft 3212 and a second end coupled to the proximal end 3214 of the piston 3202. As the crankshaft 3212 rotates by the motor 3204, the connecting rod 3210 translates the rotational motion into linear reciprocating motion of the piston 3202, driving the piston 3202 (and the attached massage node 3104, 3106) in a percussive back-and-forth motion along the longitudinal axis of the main body 3108. The stroke length of the piston 3202 is determined by the offset distance between the crankshaft coupling point and the rotational axis of the crankshaft 3212.

Motor 3204 may be a high-torque, high-frequency direct current (DC) motor designed to operate at speeds sufficient to generate rapid percussive impacts (typically in the range of at least 1,000 to 3,500 percussions or rotations per minute). As stated above, the output of motor 3204 may be mechanically linked to piston 3202 through a crankshaft or cam 3212 assembly, thereby converting rotational motion into linear percussive motion. The motor 3204 receives electrical power from the onboard power source 3206. Power source output may be regulated and monitored by a PCB/controller 3208, which may be in communication with a motor driver circuit and can control motor operation, motor speed, and safety logic. The power source 3206 may comprise of one or more rechargeable lithium-ion battery cells connected in series to produce a voltage sufficient to power motor 3204 and all associated electronic components. The battery 3206 may be disposed within the handle portion 3112 or the main body portion 3108 of the massager housing 3102. In certain embodiments, the battery 3206 may be charged through a charging cradle, a direct-connect charging port (e.g., USB-C or barrel connector), or contactless (inductive) charging. Optionally, the percussion massager 3100 may draw power from an external power source, such as a standard 110-volt or 220-volt AC outlet, through an appropriate AC-DC converter, to operate the massager 3100, to recharge the battery, or both.

As stated above, the PCB/controller 3208 may include an MCU or ASIC programmed with device control logic. The MCU or ASIC is configured to receive input signals from user controls (e.g., power buttons, speed selection buttons, temperature controls), sensor signals from the safety mechanism, and feedback signals from the motor 3204 (e.g., back-EMF sensing for speed regulation). Based on these input signals, the MCU or ASIC generates output control signals to the motor driver circuit, the electrical safety interlock circuit, and any indicator displays or LED lights on the massager 3100. The PCB/controller 3208 may further include volatile and/or non-volatile memory for storing firmware, operational parameters, safety thresholds, and user preferences.

The percussion massager 3100 may further include a user control interface disposed on the exterior of the massager housing 3102, such as on the rear panel 3114. The user control interface may include one or more physical buttons, capacitive touch sensors, a rotary dial, or a combination thereof to allow the user to control the operational state of the percussion massager 3100, including powering the device on and off, adjusting the motor speed (and thus the percussion rate and intensity), and controlling the heating and cooling effects of a temperature-controlled massage node 3104 when such a node is attached. In certain embodiments, the user control interface includes a display (such as an indicator display), such as a liquid crystal display (LCD) or organic light-emitting diode (OLED) display, that provides visual feedback to the user regarding the current operational mode, motor speed, battery level, massage node attachment status, massage node type, and temperature settings.

The percussion massager 3100 may further include an indicator display (which may be located on the user control interface on the rear panel 3114 or be located separately from the user interface on the rear panel 3114) comprising one or more indicator lights, such as LED light rings or individual LEDs, positioned on the massager housing 3102 to communicate the state of operation of the percussion massager 3100 and/or the massage node 3104, 3106 to the user. The LED indicator(s) may illuminate in different colors (e.g., green for ready/safe, red for node not detected/unsafe, blue for cooling mode active, amber for heating mode active) and/or different patterns (e.g., solid, blinking, pulsing, sequential) to convey different operational states. In certain embodiments, a specific LED indication or visual indication is provided to alert the user when the safety mechanism has detected that the massage node 3104, 3106 is absent or improperly attached, thereby informing the user of the attachment state of the massage node 3104, 3106 and that the device cannot be activated until the massage node 3104, 3106 is properly installed or attached.

As stated above, the percussion massager examples shown in FIGS. 31-37 integrate a safety mechanism that prevents motor 3204 operation unless the massage node 3104, 3106 is both present and properly attached to piston 3202. The safety mechanism may generally be described as comprising a first component disposed on the piston 3202 and a second component disposed on the massage node 3104, 3106, wherein the first component and the second component are configured to interact when the massage node 3104, 3106 is properly attached to the piston 3202. When the first component and the second component are interacting, the motor 3204 is operable. When the first component and the second component are not interacting, the motor 3204 is inoperable. The controller 3208, or any other monitoring element of the massager 3100, may monitor the state of interaction (e.g., connection state) between the first component and the second component to determine whether the massage node 3104, 3106 is properly attached. The safety mechanism is configured to ensure proper physical engagement between the piston 3202 and massage node 3104, 3106 using one or more of the following subsystems: (1) electrical safety mechanism, (2) mechanical safety mechanism, and/or (3) sensor safety mechanism. In the electrical safety mechanism, the first component may comprise one or more electrical contacts on the piston 3202 and the second component may comprise one or more electrical contacts on the massage node 3104, 3106, wherein the first and second components interact by the electrical contacts making electrical contact with each other. In the mechanical safety mechanism, the first component may comprise a mechanical switch on the piston 3202 and the second component may comprise a portion of the massage node 3104, 3106 that actuates the mechanical switch. In the sensor safety mechanism, the first component may comprise a sensor on or near the piston 3202 and the second component may comprise a detectable feature of the massage node 3104, 3106 that the sensor detects. These subsystems may be employed individually or in any combination to provide single-layer or multi-layer confirmation of proper massage node attachment. When multiple subsystems are employed, they may operate in parallel (where any single subsystem detecting non-attachment triggers motor shutdown) or in series (where all subsystems must confirm attachment before motor operation is permitted), or in a hybrid configuration. Each subsystem is described below in detail.

### Electrical Safety Mechanism

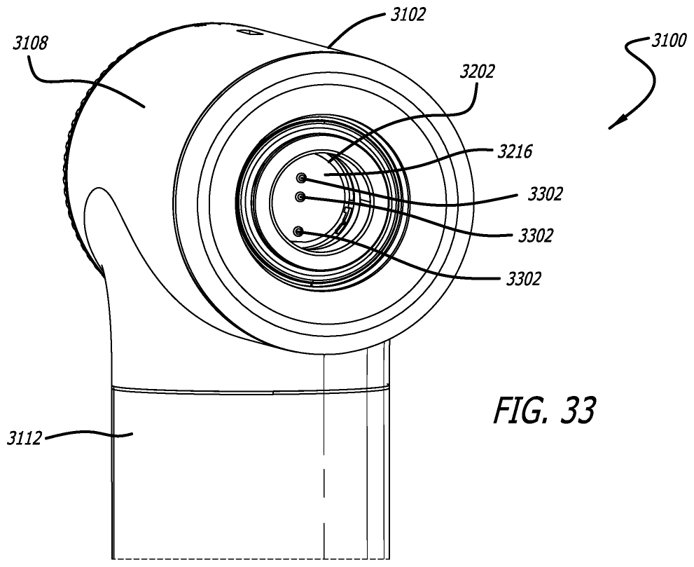

In the example illustrated in FIGS. 33-35, an electrical safety mechanism is incorporated. In particular, FIG. 33 illustrates a front perspective view of one embodiment of the percussion massager 3100 having an electrical safety mechanism without the massage node 3104, 3106 attached. The electrical safety mechanism utilizes electrical contacts disposed on both the piston 3202 (disposed at or near the distal end 3216 of the piston 3202) and the massage node 3104, 3106 (disposed at or near the lower portion of the massage node or at or near the proximal end, portion or surface of the massage node (i.e., the portion of the massage node 3104, 3106 that faces toward the piston 3202 when attached)) to establish a closed electrical circuit when the massage node 3104, 3106 is properly attached to the piston 3202. In one embodiment, as described in detail below, this closed electrical circuit is wired in series with the motor power delivery circuit such that the motor 3204 is physically and electrically incapable of receiving power unless the massage node 3104, 3106 is properly attached. In an alternative embodiment, also described below, the state of this closed electrical circuit is monitored by the PCB/controller 3208, which conditions motor 3204 operation on the circuit being in a closed state.

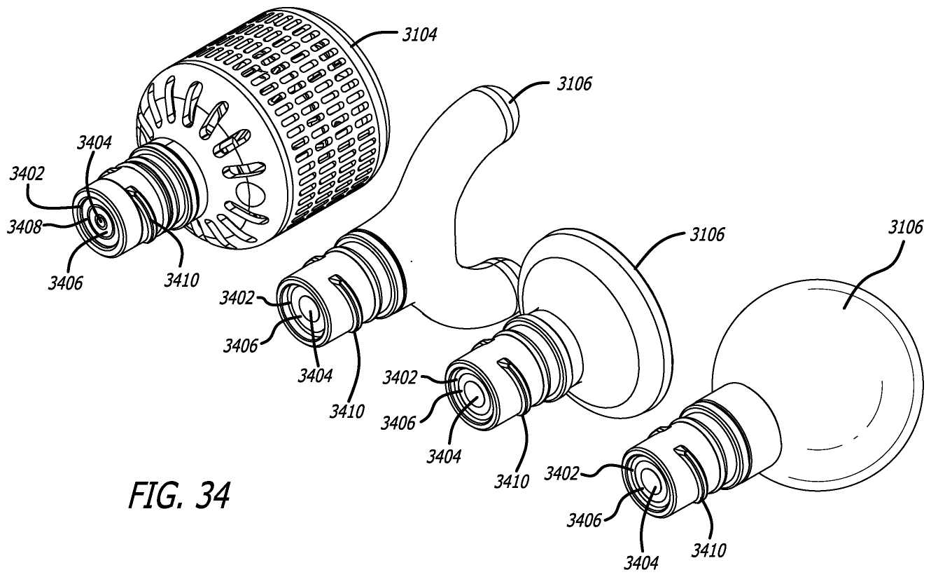

In these embodiments, the distal end 3216 of piston 3202 may include one or more electrical contact terminals 3302. These electrical contacts 3302 may be any combination or number of electrical pins (such as spring-loaded pins), electrical sockets, electrical plates (such as conductive leaf spring plates), electrical contact pads or electrical rings. In the present example, electrical contacts 3302 comprise of three spring-loaded pins. The spring-loaded pins 3302 are mounted in corresponding bores or recesses in the distal face of piston 3202, with each pin biased outwardly (i.e., toward the massage node 3104, 3106 when attached) by a compression spring disposed within the bore. The spring bias ensures that the pins 3302 maintain positive contact pressure against the corresponding contact plates 3402 (see FIG. 34) on the massage node 3104, 3106 even during the high-frequency percussive motion of the piston 3202 and despite any vibration-induced micro-movements between the piston 3202 and the massage node 3104, 3106. The spring force is selected to be sufficient to maintain reliable electrical contact under all anticipated operating conditions, while being low enough to permit easy attachment and detachment of the massage node 3104, 3106 by the user.

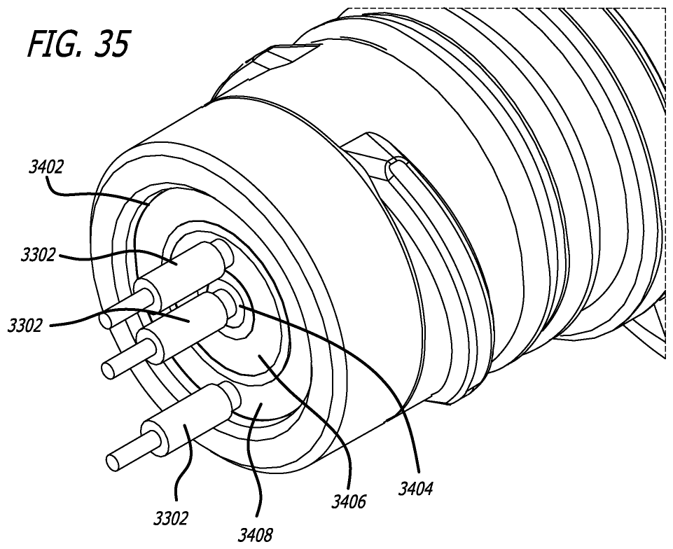

FIG. 34 illustrates rear perspective views of the multiple interchangeable massage nodes 3104, 3106 of the percussion massager 3100 and FIG. 35 illustrates a close-up view of one example of an electric connection between the massage node 3104 and the percussion massager 3100. As shown, corresponding electrical contact terminals 3402, such as electrical contact plate(s), are located on the proximal portion of massage node 3104, 3106. Similarly, electrical contacts 3402 may be any combination or number of electrical pins (such as spring-loaded pins), electrical sockets, electrical plates (such as conductive leaf spring plates), electrical contact pads or electrical rings. In the present example, electrical contacts 3402 comprises at least two concentrically arranged concentric electrical contact plates for massage node 3106 and at least three concentrically arranged concentric electrical contact plates for massage node 3104. This radial symmetry allows for rotational freedom of massage node installation, enabling users to close the electrical circuit required for motor activation by attaching massage nodes 3104, 3106 without precise alignment.

The concentric arrangement of the electrical contact plates 3402 enhances usability and reliability. Because the contact plates 3402 are arranged as concentric rings (or concentric annular bands) centered on the longitudinal axis of the massage node 3104, 3106, the spring-loaded pins 3302 on the piston 3202, which are radially positioned on the distal face of the piston 3202 to electrically contact a different one of the concentric electrical contact plates 3402, will make contact with the appropriate corresponding contact plate 3402 independent or regardless of the rotational orientation of the massage node 3104, 3106 relative to piston 3202 when attached to piston 3202. This means that the user does not need to rotationally align the massage node 3104, 3106 with the piston 3202 when attaching the node, which simplifies the attachment process and reduces the likelihood of improper attachment due to rotational misalignment.

The number of electrical contact terminals disposed on piston 3202 and/or each massage node 3104, 3106 may vary depending on the functional requirements of the particular massage node type. Because different massage node types incorporate different functional components (also referred to herein as active components), each node type may require a different number of discrete electrical pathways between the piston 3202 and the massage node 3104, 3106 to support its intended operation. The electrical contact configuration for each node type is designed to provide the minimum number of contacts necessary to satisfy both the electrical safety interlock function and the power and signal delivery requirements of the massage node's active components, if any.

In certain embodiments, the electrical contacts 3402 in the dummy massage nodes 3106 (i.e., a massage node that does not include active electrical components such as a thermoelectric heater/cooler, fan, temperature sensor, independent power source, or onboard controller) includes two electrical contacts 3404, 3406. The two electrical contact terminals on the dummy massage node 3106 are electrically interconnected within the node body by a conductive trace, conductive jumper wire, or other conductive pathway. When the dummy massage node 3106 is attached to the piston 3202, two of the spring-loaded pins 3302 (or other electrical contact terminals) on the piston 3202 make contact with the two corresponding contact terminals on the dummy massage node 3106, and electrical current flows from the first pin, through a conductive pathway within the dummy node, and returns through the second pin, thereby forming a closed-loop circuit. This closed-loop circuit is the minimum circuit configuration required to establish electrical continuity between the piston 3202 and massage node 3106. Because the dummy massage node 3106 has no active components that require power delivery or signal communication, the two-contact configuration is sufficient to satisfy the electrical safety interlock function without any additional electrical contacts.

In this two-contact configuration, dummy massage node 3106 includes two concentric plates that may be arranged as an innermost circular contact plate 3404 and a middle annular contact plate 3406 surrounding the innermost plate 3404. Each plate or ring 3404, 3406 is electrically isolated from adjacent plates or rings by insulating gaps or dielectric barriers disposed between the plates or rings. As shown in FIG. 35, at least two of the spring-loaded pins 3302 on piston 3202 are positioned and spaced sufficiently apart from one another such that each pin 3302 aligns with a different one of the contact plates 3404, 3406, ensuring that each pin 3302 contacts its designated plate regardless of the rotational position of the massage node 3106. The widths of the plates 3404, 3406 and the positions of the pins 3302 are selected to provide sufficient contact overlap to maintain reliable electrical connection under all anticipated operating conditions, including conditions of vibration and percussive motion.

Alternatively, the illustrated temperature-controlled massage node 3104 may include three or more electrical contact terminals because the temperature-controlled node incorporates active electrical components that require dedicated electrical pathways beyond the minimum closed-loop circuit needed for the electrical safety interlock function. In this example, the electrical contacts 3402 of temperature-controlled massage node 3104 may be arranged as an innermost circular contact plate 3404, a middle annular contact plate 3406 surrounding the innermost plate 3404, and an outermost annular contact plate 3408 surrounding the middle annular contact plate 3404. Each plate 3404, 3406, 3408 is also electrically isolated from adjacent plates or rings by insulating gaps or dielectric barriers disposed between the plates or rings.

As shown in FIG. 35, the three spring-loaded pins 3302 on piston 3202 are positioned and spaced sufficiently apart from one another such that each pin 3302 aligns with a different one of the contact plates 3404, 3406, 3408 ensuring that each pin 3302 contacts its designated plate regardless of the rotational position of the massage node 3106. The widths of the plates 3404, 3406, 3408 and the positions of the pins 3302 are selected to provide sufficient contact overlap to maintain reliable electrical connection under all anticipated operating conditions, including conditions of vibration and percussive motion.

In the three-contact plate arrangement, a first contact terminal may be connected to a hot wire (i.e., a power supply conductor that carries current from the power source 3206 to the active components within the node 3104), a second contact terminal may be connected to a neutral wire (i.e., a return conductor that carries current back from the active components to the power source, completing the power delivery circuit), and a third contact terminal may be connected to a ground wire (i.e., a dedicated safety ground conductor that provides an alternate low-impedance return path for current in the event of an electrical fault, such as a short circuit between the Peltier plate and the node housing).

Alternatively, in the three-contact arrangement, the first contact terminal may serve as a power supply conductor, the second contact terminal may serve as a ground return conductor, and the third contact terminal may carry an integrated circuit (IC) data signal or control signal. In this alternative configuration, the temperature-controlled massage node 3104 includes a separate printed circuit board (PCB) or integrated circuit (IC) 2008 disposed within the massage node housing. The onboard PCB or IC 2008 receives the data signal or control signal from the PCB/controller 3208 through the third contact terminal and parses the signal to independently control the operation of the thermoelectric heater/cooler (e.g., Peltier plate), fan, and temperature sensor within the node 3104. This onboard control architecture allows the massage node 3104 to manage multiple active components through a single data signal line.

Alternatively, in the three-contact arrangement, the first contact terminal may serve as a power supply conductor (to power the active components within the node 3104), and the second and third contact terminals may serve to close the electrical circuit for motor activation through an internal conductive pathway in massage node 3104.

In both the two-contact dummy node 3106 configuration and the three-contact temperature-controlled node 3104 configuration, the electrical safety interlock function is preserved. In both types of nodes 3104, 3106, the closed-loop circuit may be formed by at least two of the contacts and the internal conductive pathway satisfying the continuity requirement of the safety interlock. When the closed-loop circuit is formed, the electrical power path (or motor power delivery circuit) is in a closed state, and the motor 3204 is operable. When the closed-loop circuit is not formed, the electrical power path is in an open state, and the motor 3204 is inoperable. In either case, an open circuit on any contact indicates that the massage node 3104, 3106 is absent or improperly attached, and the motor 3204 is prevented from operating in accordance with the electrical safety interlock logic and configuration described herein.

It should be understood that the two-contact and three-contact configurations described above are exemplary and non-limiting. Other contact configurations may be employed depending on the functional requirements of the particular massage node type. For example, a six-pin configuration may be incorporated, where two of the pins may be allocated to the thermoelectric heater/cooler signal (power and return), two pins may be allocated to a fan signal (power and return), and two pins may be allocated to a temperature sensor signal (signal and return). In a four-pin configuration, one pin may provide power, one pin may provide a ground return, one pin may carry an identification or data signal (e.g., for identifying the type of massage node attached), and one pin may be dedicated to the electrical safety interlock circuit. Other pin counts and functional allocations are contemplated and fall within the scope of the invention. Further, the concentric contact plate arrangement described above accommodates varying numbers of contact terminals by incorporating additional concentric rings or plates as needed, with each ring or plate electrically isolated from adjacent rings or plates by insulating gaps.

As stated above, in one embodiment, the electrical safety mechanism operates as a direct-circuit hardware interlock in which the electrical contacts 3302 on the piston 3202 and the corresponding electrical contacts 3402 on the massage node 3104, 3106 are wired in series with the motor power delivery circuit (also referred to herein as the electrical power path) itself. In this configuration, the electrical contacts 3302, 3402 are electrically interposed between the power source 3206 and the motor 3204. In this configuration, the motor power delivery circuit (or electrical power path) includes a physical gap or interruption at the interface between the piston 3202 and the massage node 3104, 3106 that prevents electrical power from reaching the motor 3204 unless and until the gap is bridged by the electrical contacts 3402 on a properly attached massage node 3104, 3106, thereby acting as an electrical kill switch. When the massage node 3104, 3106 is not attached, the electrical power path is interrupted at the interface between the piston 3202 and the massage node 3104, 3106, and the motor 3204 is inoperable. When the massage node 3104, 3106 is attached and the electrical contacts 3302, 3402 make electrical contact, the electrical power path is continuous through the interface, and the motor 3204 is operable. In this embodiment, it is not necessary for the PCB/controller 3208 to actively check, poll, or monitor the status of the circuit to determine whether the massage node 3104, 3106 is present. When the massage node 3104, 3106 is absent or improperly attached, the motor power delivery circuit remains physically open, and no electrical power can reach the motor 3204 regardless of the state of the PCB/controller 3208 or any user input.

In certain embodiments employing the direct-circuit hardware interlock, the electrical contacts 3302, 3402 may be disposed in series with the motor driver circuit output, such that the switched output of the motor driver circuit passes through the electrical contacts 3302, 3402 at the piston-node interface before reaching the motor 3204. In this configuration, the PCB/controller 3208 retains control over motor speed and operational modes through the motor driver circuit, but the motor driver circuit output is physically routed through the piston-node electrical contacts such that the motor driver circuit output cannot reach the motor 3204 unless the contacts are closed by a properly attached massage node 3104, 3106.

In other embodiments, the electrical contacts 3302, 3402 may be disposed in series with the power supply line upstream of the motor driver circuit, such that no power reaches either the motor driver circuit or the motor 3204 unless the contacts are closed by a properly attached massage node 3104, 3106.

In yet other embodiments, the electrical contacts 3302, 3402 may be wired to an enable input of the motor driver circuit, such that the motor driver circuit is held in a disabled state unless the enable input receives a signal that can only be provided when the electrical contacts 3302, 3402 are closed by a properly attached massage node 3104, 3106. In this configuration, the motor driver circuit itself acts as the electrical switching element that prevents power delivery to the motor 3204, but the electrical switching element is controlled directly by the hardware state of the piston-node electrical contacts.

In the direct-circuit hardware interlock embodiment, if the massage node 3104, 3106 becomes dislodged, loosened, or detached from the piston 3202 during operation, the electrical contacts 3302, 3402 separate, the motor power delivery circuit (or electrical power path) is immediately interrupted, the circuit is physically opened, and power delivery to the motor 3204 ceases instantaneously without any intervening processing delay.

In the two-contact dummy massage node 3106, the direct-circuit hardware interlock is implemented by routing the motor power delivery circuit through two of the three spring-loaded pins 3302 on the piston 3202 and through the corresponding two concentric contact plates 3404, 3406 on the dummy massage node 3106. More specifically, the motor power delivery circuit includes a first conductor that carries motor drive current from the motor driver circuit (or, in embodiments where the contacts are upstream of the motor driver circuit, from the power source 3206) to a first one of the spring-loaded pins 3302 on the piston 3202. The first spring-loaded pin 3302 is aligned with one of the two concentric contact plates (e.g., the innermost circular contact plate 3404) on the dummy massage node 3106. When the dummy massage node 3106 is properly attached to the piston 3202, the first spring-loaded pin 3302 makes contact with the first contact plate 3404, and current flows from the first pin 3302 into the dummy massage node 3106 through the first contact plate 3404. Within the body of the dummy massage node 3106, the first contact plate 3404 is electrically connected to the second contact plate (e.g., the middle annular contact plate 3406) by a conductive trace, conductive jumper wire, or other conductive pathway, as described above. The current therefore flows from the first contact plate 3404, through the internal conductive pathway, to the second contact plate 3406. The second contact plate 3406 is aligned with a second one of the spring-loaded pins 3302 on the piston 3202. The current flows from the second contact plate 3406 into the second spring-loaded pin 3302 and returns via a second conductor to the motor driver circuit (or power source 3206), thereby completing the motor power delivery circuit.

When the dummy massage node 3106 is absent or improperly attached to the piston 3202, the first and second spring-loaded pins 3302 do not make proper electrical contact with the corresponding contact plates 3404, 3406, and the motor power delivery circuit remains physically open at the piston face. The third spring-loaded pin 3302 on the piston 3202, which may not have any corresponding contact plate on the dummy massage node 3106, remains electrically idle and serves no function when the dummy massage node 3106 is attached.

In the three-contact temperature-controlled massage node 3104, the direct-circuit hardware interlock must accomplish two functions simultaneously: Closing the motor power delivery circuit to permit motor operation and delivering electrical power and/or signals to the active components within the massage node 3104 (e.g., a thermoelectric heater/cooler such as a Peltier plate, fan, temperature sensor, one or more light-emitting elements for light therapy, one or more vibration motors, and/or one or more ultrasonic transducers). Several configurations are contemplated for achieving both functions through the three electrical contact terminals.

In one configuration, two of the three contact terminals are dedicated to the motor power delivery circuit, and the third contact terminal is dedicated to delivering power to the active components within the massage node 3104. More specifically, the motor power delivery circuit is routed through a first spring-loaded pin 3302 on the piston 3202, through the corresponding first contact plate (e.g., the innermost circular contact plate 3404) on the massage node 3104, through an internal conductive pathway within the massage node 3104 that connects the first contact plate 3404 to a second contact plate (e.g., the middle annular contact plate 3406), and back through a second spring-loaded pin 3302 corresponding to the second contact plate 3406 to complete the motor power delivery circuit. This internal conductive pathway is separate from and electrically isolated from the circuits connecting the active components within the massage node 3104. The third spring-loaded pin 3302 is aligned with the remaining contact plate (e.g., the outermost annular contact plate 3408) and serves as a power supply conductor that carries current from the power source 3206 to the active components (e.g., a thermoelectric heater/cooler such as a Peltier plate, fan, temperature sensor, one or more light-emitting elements for light therapy, one or more vibration motors, and/or one or more ultrasonic transducers) within the massage node 3104. The return path for the active component current may share a common ground through one of the motor interlock contact plates, or may be provided through a separate internal pathway.

It should be understood that the foregoing configurations are exemplary and non-limiting. The direct-circuit hardware interlock may be implemented with any number of electrical contact terminals and with any functional allocation of those terminals, provided that at least two of the electrical contact terminals are wired in series with the motor power delivery circuit (or wired to a hardware enable input of the motor driver circuit) such that the motor power delivery circuit is physically interrupted when the massage node 3104, 3106 is absent or improperly attached. In embodiments having four or more electrical contact terminals, one or more pairs of contact terminals may be dedicated to the motor interlock circuit while the remaining contact terminals are allocated to power delivery, data signals, identification signals, and/or safety ground functions as required by the particular massage node type. The concentric contact plate arrangement described above readily accommodates these varying configurations by incorporating additional concentric rings or plates as needed.

Alternatively, or in addition to the direct-circuit hardware interlock described above, the electrical safety mechanism may be implemented as a controller-monitored interlock. In this alternative embodiment, the closed-loop circuit formed by the electrical contacts 3302, 3402 is not wired in series with the motor power delivery circuit. Instead, the closed-loop circuit serves as a detection or sensing circuit that is monitored by the PCB/controller 3208. The PCB/controller 3208 determines a connection state between the electrical contacts 3302 and the electrical contacts 3402. The connection state indicates either electrical contact (when the massage node 3104, 3106 is attached and the contacts 3302, 3402 are in electrical contact with each other) or a lack of electrical contact (when the massage node 3104, 3106 is absent or improperly attached and the contacts 3302, 3402 are not in electrical contact with each other). The PCB/controller 3208 is configured to enable operation of the motor 3204 when the connection state indicates electrical contact and to disable operation of the motor 3204 when the connection state does not indicate electrical contact. More generally, the PCB/controller 3208 conditions motor 3204 operation on the detection circuit being in a closed state by enabling or disabling the motor driver circuit through a software-generated control signal based on the monitored state of the detection circuit.

In this alternative embodiment, when the massage node 3104, 3106 is attached to piston 3202, electrical continuity is established between the piston 3202 and massage node 3104, 3106 by the electrical connection between electrical contacts 3302 and electrical contacts 3402. This electrical connection forms a closed-loop circuit that is in communication with PCB/controller 3208. The circuit may optionally include resistive, capacitive, or digital identification signatures to validate the authenticity or compatibility of the attached massage node 3104, 3106.

In certain embodiments of the controller-monitored interlock, the PCB/controller 3208 is configured to not only determine whether a massage node 3104, 3106 is properly attached to the piston 3202, but also to identify the type of massage node attached and to automatically adjust one or more operational parameters of the percussion massager 3100 in response to the identified node type. Different types of massage nodes 3104 may be designed to deliver different therapeutic modalities, including but not limited to percussive therapy, temperature-controlled therapy (heating and/or cooling), light therapy (e.g., red light therapy, blue light therapy, infrared light therapy, or multicolor light therapy), and vibration therapy (e.g., ultrasonic vibration therapy). Each massage node type may include a node identification element that communicates the node type to the PCB/controller 3208 through the electrical contacts 3302, 3402 when the massage node is attached to the piston 3202.

The node identification element may take several forms. In one embodiment, the node identification element comprises a resistive identification element, such as a precision resistor or resistor network, disposed within the massage node 3104 and electrically connected between two or more of the electrical contacts 3402. Each massage node type includes a resistor of a different known resistance value, and the PCB/controller 3208 measures the resistance across the corresponding electrical contacts 3302 to identify the node type. For example, a temperature-controlled massage node may include a first resistance value, a light therapy massage node may include a second resistance value different from the first resistance value, an ultrasonic vibration massage node may include a third resistance value different from the second resistance value, and a standard percussion-only (dummy) massage node may include a fourth resistance value different from the third resistance value or may include a simple short circuit (i.e., zero resistance, formed by the conductive pathway described above). The PCB/controller 3208 compares the measured resistance to a lookup table or set of predetermined threshold ranges stored in memory to identify the node type.

In another embodiment, the node identification element comprises a digital identification device (such as a one-wire serial Electrically Erasable Programmable Read-Only Memory (EEPROM), Radio-frequency identification (RFID) tag, Near-Field Communication (NFC) chip, or other digital communication device), disposed within the massage node 3104 and electrically connected to one or more of the electrical contacts 3402. The digital identification device stores identification data, which may include the node type, node model number, serial number, manufacturing date, recommended operational parameters (e.g., maximum percussion speed, temperature range, light wavelength, vibration frequency), and cumulative usage data (e.g., total operating hours, number of attachment cycles). When the massage node 3104 is attached to the piston 3202, the PCB/controller 3208 reads the identification data from the digital identification device through the electrical contacts 3302, 3402 and uses the identification data to identify the node type and configure the operational parameters of the percussion massager 3100 accordingly.

In yet another embodiment, the node identification element comprises a capacitive or inductive signature element that produces a characteristic capacitance or inductance value that the PCB/controller 3208 measures and compares to known values to identify the node type. Other identification methods are also contemplated, including but not limited to optical encoding (e.g., a pattern of reflective or absorptive markings on the massage node that are read by an optical sensor), magnetic encoding (e.g., a specific arrangement of magnets within the massage node that produces a characteristic magnetic field pattern detectable by one or more Hall-effect sensors), or mechanical encoding (e.g., a physical keying feature on the massage node that engages a corresponding feature on the piston to permit or prevent attachment of certain node types).

As described above, the interchangeable massage nodes 3104 may include temperature-controlled massage nodes having a thermoelectric heater/cooler (e.g., a Peltier plate) configured to impart heating or cooling effects on the user, as described in detail in connection with FIGS. 1-30. In addition to temperature-controlled massage nodes, the present invention contemplates massage nodes configured to deliver other therapeutic modalities, including light therapy massage nodes and ultrasonic vibration massage nodes, each of which is described below.

A light therapy massage node is a massage node 3104 that includes one or more light-emitting elements configured to emit therapeutic light at one or more predetermined wavelengths onto the user's skin during massage. The light-emitting elements may comprise one or more LED's, laser diodes, organic light-emitting diodes (OLEDs), or other solid-state light sources disposed within or on the massage node housing and oriented to direct light outwardly through a light-transmissive portion of the contact surface of the massage node toward the user's skin. The light-transmissive portion may be, for example, a transparent or translucent window, lens, or diffuser integrated into the contact surface of the massage node.

The light therapy massage node may be configured to emit light at wavelengths corresponding to one or more recognized therapeutic light therapy modalities. For example, a red light therapy massage node may emit light at wavelengths in the range of approximately 620 nm to 700 nm, which is associated with promoting collagen production, reducing inflammation, and accelerating wound healing. A near-infrared light therapy massage node may emit light at wavelengths in the range of approximately 700 nm to 1100 nm, which is associated with deeper tissue penetration and pain relief. A blue light therapy massage node may emit light at wavelengths in the range of approximately 400 nm to 490 nm, which is associated with antibacterial effects and treatment of acne and other skin conditions. A multicolor or multi-wavelength light therapy massage node may include LED's of two or more different wavelengths (e.g., both red and near-infrared, or red, blue, and near-infrared) and may be configured to operate the different wavelengths simultaneously, sequentially, or in user-selectable combinations.

The light-emitting elements in the light therapy massage node receive electrical power from the power source 3206 through the electrical contacts 3302, 3402 when the light therapy massage node is attached to the piston 3202. In embodiments where the light therapy massage node includes a node identification element, the PCB/controller 3208 identifies the attached node as a light therapy node and may automatically enable light therapy control functions on the user control interface 3114 and/or the indicator display. The PCB/controller 3208 may control the intensity, wavelength selection, pulse frequency, duty cycle, and duration of the light output through one or more of the electrical contacts 3302, 3402. In embodiments where the light therapy massage node includes an onboard PCB or IC, the onboard controller may parse control signals from the PCB/controller 3208 to independently manage the light-emitting elements.

The light therapy massage node may be used with or without the percussive massage effect. In certain embodiments, the user may activate the light therapy function independently of the percussion function, such that the light therapy massage node emits therapeutic light while the piston 3202 is stationary. In other embodiments, the light therapy function and the percussion function may operate simultaneously, delivering combined percussive and light therapy to the user. The PCB/controller 3208 may control the operational modes of both the percussion function and the light therapy function, including enabling or disabling each function independently or in predetermined combinations.

An ultrasonic vibration massage node is a massage node 3104 that includes one or more ultrasonic transducers configured to generate high-frequency mechanical vibrations at ultrasonic frequencies (i.e., frequencies above approximately 20 kHz and typically in the range of approximately 20 kHz to 3 MHz, depending on the therapeutic application). The ultrasonic transducers may comprise one or more piezoelectric elements, magneto strictive elements, or other electromechanical transducer elements disposed within the massage node housing and mechanically coupled to the contact surface of the massage node such that the ultrasonic vibrations are transmitted through the contact surface to the user's skin and underlying tissue.

Ultrasonic vibration therapy is a therapeutic modality that promotes blood circulation, reduces muscle tension, accelerates tissue repair, and facilitates the absorption of topical therapeutic agents (e.g., analgesic creams, anti-inflammatory gels) through a process known as phonophoresis or sonophoresis. The frequency and intensity of the ultrasonic vibrations may be selected based on the intended therapeutic application. For example, lower ultrasonic frequencies (e.g., approximately 20 kHz to 100 kHz) may be used for deeper tissue penetration and muscle therapy, while higher ultrasonic frequencies (e.g., approximately 1 MHz to 3 MHz) may be used for superficial tissue treatment and skin therapy.

The ultrasonic transducers in the ultrasonic vibration massage node receive electrical power from the power source 3206 through the electrical contacts 3302, 3402 when the ultrasonic vibration massage node is attached to the piston 3202. The PCB/controller 3208 may generate a high-frequency electrical drive signal at the desired ultrasonic frequency and transmit the drive signal to the ultrasonic transducers through one or more of the electrical contacts 3302, 3402. Alternatively, the ultrasonic vibration massage node may include an onboard driver circuit or oscillator that generates the high-frequency drive signal locally within the massage node, receiving only DC power and/or a control signal from the PCB/controller 3208 through the electrical contacts 3302, 3402. In embodiments where the ultrasonic vibration massage node includes a node identification element, the PCB/controller 3208 identifies the attached node as an ultrasonic vibration node and may automatically enable ultrasonic vibration control functions on the user control interface 3114 and/or the indicator display.

The ultrasonic vibration massage node may be used with or without the percussive massage effect. In certain embodiments, the user may activate the ultrasonic vibration function independently of the percussion function, such that the ultrasonic vibration massage node delivers ultrasonic therapy while the piston 3202 is stationary. In other embodiments, the ultrasonic vibration function and the percussion function may operate simultaneously, delivering combined percussive and ultrasonic vibration therapy to the user. The PCB/controller 3208 may control the operational modes of both the percussion function and the ultrasonic vibration function, including enabling or disabling each function independently or in predetermined combinations.

Upon identifying the type of massage node attached to the piston 3202, the PCB/controller 3208 is configured to automatically adjust one or more operational parameters of the percussion massager 3100 and to update the user control interface 3114 and/or indicator display to reflect the capabilities and control options of the identified node type. This automatic adjustment ensures that the user is presented with only the control options and display information that are relevant to the attached node type, which simplifies the user experience, reduces the likelihood of user error, and ensures that the correct operational parameters are applied for the particular therapeutic modality.

The operational parameters that the PCB/controller 3208 may adjust in response to the identified node type include, but are not limited to: (a) the maximum and minimum percussion speed (percussions per minute); (b) the percussion intensity or stroke amplitude; (c) whether the heating and/or cooling function is enabled or disabled; (d) the temperature range and preset temperature options for a temperature-controlled massage node; (e) whether the light therapy function is enabled or disabled; (f) the light wavelength, intensity, pulse frequency, duty cycle, and duration for a light therapy massage node; (g) whether the ultrasonic vibration function is enabled or disabled; (h) the ultrasonic frequency, intensity, and waveform for an ultrasonic vibration massage node; and (i) any preset therapy programs or operational modes specific to the identified node type.

The user control interface 3114 and/or indicator display may be updated by the PCB/controller 3208 in several ways upon identification of the node type. In embodiments where the user control interface 3114 includes an LCD or OLED display, the display may change its graphical layout, menu structure, icons, labels, and available control options to correspond to the identified node type. For example, when a temperature-controlled massage node is identified, the display may present temperature controls, temperature readout, and heating/cooling mode selection options. When a light therapy massage node is identified, the display may present light wavelength selection, light intensity controls, and treatment timer options. When an ultrasonic vibration massage node is identified, the display may present ultrasonic frequency selection, intensity controls, and treatment mode options. When a standard percussion-only (dummy) massage node 3106 is identified, the display may present only percussion speed and intensity controls, with all other therapeutic function controls hidden or disabled.

In embodiments where the user control interface 3114 includes physical buttons or touch sensors, the PCB/controller 3208 may reassign the function of one or more buttons or touch zones based on the identified node type. For example, a button that controls temperature when a temperature-controlled node is attached may be reassigned to control light intensity when a light therapy node is attached, or to control ultrasonic frequency when an ultrasonic vibration node is attached.

The indicator display (e.g., LED light ring or individual LEDs) may also be updated by the PCB/controller 3208 to reflect the identified node type. For example, the indicator display may illuminate in a first color (e.g., red or blue) when a temperature-controlled massage node is identified, indicating heating or cooling mode availability. The indicator display may illuminate in a second color (e.g., green) when a light therapy massage node is identified. The indicator display may illuminate in a third color (e.g., amber or purple) when an ultrasonic vibration massage node is identified. The indicator display may illuminate in a fourth color (e.g., white) when a standard percussion-only massage node is identified. Other color combinations, patterns, and illumination effects are also contemplated to convey different node types and operational states.

If the PCB/controller 3208 is unable to identify the node type (e.g., because the massage node does not include a node identification element, or because the identification data is corrupted or unreadable), the PCB/controller 3208 may default to a basic operational mode in which only percussion controls are available on the user control interface 3114, and no therapeutic function controls are enabled. Alternatively, the PCB/controller 3208 may alert the user through the indicator display that the node type is unrecognized, and may prompt the user to manually select the node type through the user control interface 3114. In certain embodiments, the PCB/controller 3208 may prevent motor operation entirely if the node type cannot be identified, as an additional safety measure to prevent the application of incorrect operational parameters to an unknown node type.

In the controller-monitored embodiment, the PCB/controller 3208 may further be configured to include a logic circuit or analog comparator that continuously monitors the connection state by continuously checking the status of the closed-loop circuit. The PCB/controller 3208 may continuously monitor the connection state during operation of the motor 3204 and disable operation of the motor 3204 upon detecting a change in the connection state. If the circuit is open (i.e., the massage node 3104, 3106 is missing or improperly attached to piston 3202, or has become dislodged from piston 3202, and the connection state does not indicate electrical contact), a signal is sent to the motor driver circuit to disable power delivery to the motor 3204, thereby acting as an electrical kill switch.

In the controller-monitored embodiment, this system may further include fail-safe timers, watchdog circuits, and redundant interlocks to ensure no power is delivered during unverified states. The fail-safe timers and watchdog circuits serve as secondary safety layers that operate independently of the primary electrical safety interlock logic. A watchdog timer is a hardware or firmware-based timer that must be periodically reset (“kicked”) by the MCU of controller 3208 during normal operation. If the MCU fails to reset the watchdog timer within a predetermined timeout period (indicating a software hang, crash, or other MCU malfunction), the watchdog timer generates a system reset or directly disables the motor driver circuit, ensuring that the motor 3204 cannot operate in an uncontrolled state.

The PCB/controller 3208 may further implement a startup verification sequence that is executed each time the user activates the percussion massager 3100 (e.g., by pressing the power button). During the startup verification sequence, the PCB/controller 3208 performs a series of self-diagnostic checks, including one or more of the following: (a) verifying the integrity of the electrical safety interlock circuit by measuring the continuity and/or resistance of the closed-loop circuit formed by the electrical contacts 3302 and contacts 3402; (b) verifying the operational status of the watchdog timer; (c) verifying the battery voltage level to ensure sufficient power for safe operation; and (d) optionally, reading identification data from the attached massage node 3104, 3106 to verify compatibility. Only upon successful completion of the applicable startup verification checks does the PCB/controller 3208 enable the motor driver circuit to permit motor 3204 operation. If any check fails, the PCB/controller 3208 prevents motor activation and may activate an indicator (e.g., a red LED or an error code on the display 3114) to alert the user.

In other examples, the electrical safety mechanism may include debounce filters or delay circuits to prevent false positives caused by vibration-induced and rapid percussive movement contact fluctuations. Debounce filtering is particularly important in the context of a percussion massager because the high-frequency reciprocating motion of the piston 3202 may cause momentary interruptions in electrical contact between the pins 3302 and the plates 3402, even when the massage node 3104, 3106 is properly attached. Without debounce filtering, these momentary contact interruptions could cause the safety mechanism to falsely detect a node-absent condition and unnecessarily shut down the motor 3204, resulting in unacceptable operational intermittency. The debounce filter may be implemented in hardware or in firmware. The debounce threshold is carefully calibrated to be long enough to filter out vibration-induced contact bounce but short enough to ensure rapid response to a genuine node-detachment event.

The electrical contact materials for contacts 3302, 3402 may be gold-plated copper, nickel alloy, or any other conductive metals, particularly materials with low contact resistance and corrosion resistance. The contact arrangement may also be waterproof or conformally coated to withstand sweat or moisture ingress typical during massager use.

### Mechanical Safety Mechanism

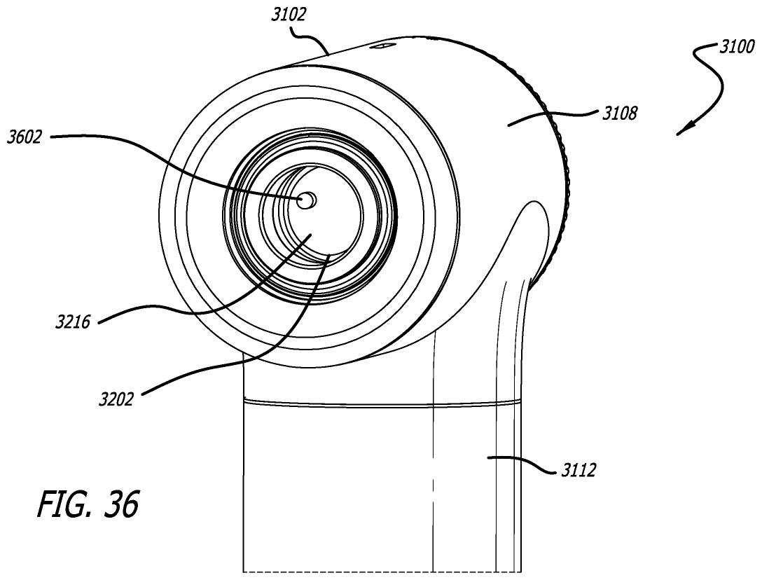

FIG. 36 illustrates a front perspective view of another embodiment of the percussion massager 3100 having a mechanical safety mechanism without the massage node 3104, 3106 attached. In this example, in addition to or alternatively to the electrical safety mechanism described above, the piston 3202 may incorporate a mechanical actuator or switch 3602, such as a momentary tactile switch or plunger-style microswitch, positioned on or positioned near the distal end 3216 of piston 3202. In the illustrated embodiment, the mechanical switch 3602 is disposed on the distal face of the distal end 3216 of piston 3202, centered on or near the longitudinal axis of the piston 3202, such that the switch 3602 protrudes slightly beyond the distal face of the distal end 3216 of piston 3202 when in the non-actuated (default) state. As with the electrical safety mechanism described above, the mechanical switch 3602 may be implemented as a direct-circuit hardware interlock, as a controller-monitored interlock, or as a combination of both.

In one embodiment, the mechanical switch 3602 is wired in series with the motor power delivery circuit such that the motor power delivery circuit includes a physical interruption at the switch 3602 that can only be closed when the massage node 3104, 3106 is properly attached to the piston 3202 and the switch 3602 is depressed or actuated, thereby acting as a mechanical kill switch. In this direct-circuit configuration, the motor 3204 will not activate unless the mechanical switch 3602 is in its closed (actuated) state. It is not necessary for the PCB/controller 3208 to monitor the state of the switch 3602 to enforce the safety interlock; the switch 3602 itself is a physical component of the motor power delivery circuit.

The mechanical switch 3602 is configured to be depressed only when the massage node 3104, 3106 is properly attached to piston 3202. When the massage node 3104, 3106 is properly coupled to the piston 3202, the proximal face or mounting surface of the massage node 3104, 3106 presses against the switch 3602, causing the switch 3602 to depress and transition from an open (non-actuated) state to a closed (actuated) state. When the massage node 3104, 3106 is absent, the switch 3602 remains in its default open (non-actuated) state, and no electrical power can reach the motor 3204.

If the massage node 3104, 3106 becomes dislodged, loosened, or detached from the piston 3202 during operation, the switch 3602 returns to its default open (non-actuated) state and power delivery to the motor 3204 ceases instantaneously.

The mechanical switch 3602 may be wired in any of the configurations described above in connection with the direct-circuit electrical interlock, including in series with the motor driver circuit output, in series with the power supply line upstream of the motor driver circuit, or to a hardware enable input of the motor driver circuit.

Alternatively, or in addition to the direct-circuit mechanical hardware interlock described above, the mechanical switch 3602 may be implemented as a controller-monitored interlock. In this alternative embodiment, the mechanical switch 3602 is not wired in series with the motor power delivery circuit. Instead, the switch 3602 is connected to a detection input on the PCB/controller 3208, and the PCB/controller 3208 monitors the state of the switch 3602 (open or closed) to determine whether the massage node 3104, 3106 is properly attached. In the controller-monitored embodiment, depressing the switch 3602 completes a detection circuit, which the PCB/controller 3208 interprets as an indication that the massage node 3104, 3106 is securely attached. The PCB/controller 3208 receives this signal and enables the motor driver circuit to permit motor 3204 operation.

In the controller-monitored embodiment, if the mechanical switch 3602 is not depressed or not fully or properly depressed (thereby indicating the absence or inadequate attachment of massage node 3104, 3106), the PCB/controller 3208 does not enable the motor driver circuit and the motor 3204 will not be operable. If the switch 3602 is momentarily released during operation due to loosening or detachment of massage node 3104, 3106, the PCB/controller 3208 will immediately disable operation of motor 3204, thereby acting as a mechanical kill switch.

In both the direct-circuit and controller-monitored embodiments of the mechanical safety mechanism, the use of the mechanical actuation switch 3602 adds tactile certainty and redundancy to the system, serving as a physical confirmation layer over other detection methods. The tactile feedback provided by the mechanical switch 3602 also provides the user with a perceptible confirmation that the massage node 3104, 3106 is properly seated against the piston 3202, because the user may feel or hear the “click” of the switch 3602 being depressed when the node 3104, 3106 is fully inserted. This tactile or audible feedback serves as an additional user-facing safety indicator, complementing any visual indicators provided by the LED display or other indicator systems described herein.

It should be understood that all features and functions described in connection with the electrical safety mechanism are equally applicable to the mechanical safety mechanism described herein. In particular, all types of interchangeable massage nodes described in connection with the electrical safety mechanism, including temperature-controlled massage nodes, light therapy massage nodes, and ultrasonic vibration massage nodes, may be used with the mechanical safety mechanism. Further, the node identification system, including resistive identification, digital identification, and all other identification methods described in connection with the electrical safety mechanism, may be incorporated into embodiments employing the mechanical safety mechanism. When the mechanical safety mechanism is used in combination with electrical contacts (e.g., in a multi-layer redundancy configuration), the PCB/controller 3208 may identify the type of massage node attached and automatically adjust the operational parameters, user control interface, and indicator display in the same manner as described in connection with the electrical safety mechanism. When the mechanical safety mechanism is used without electrical contacts, the PCB/controller 3208 may identify the node type through alternative means, such as a mechanical keying feature, an optical encoding pattern, or a magnetic encoding arrangement on the massage node, and may adjust the operational parameters, user control interface, and indicator display accordingly.

### Sensor Safety Mechanism

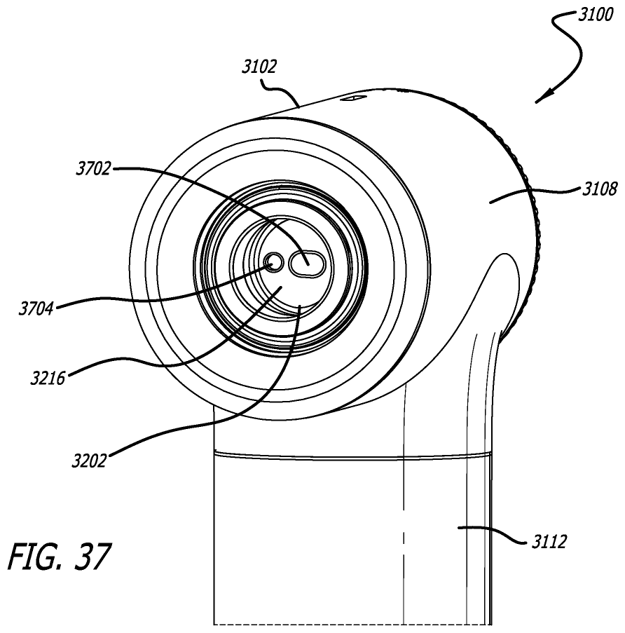

FIG. 37 illustrates a front perspective view of yet another embodiment of the percussion massager 3100 having a sensor safety mechanism without the massage node 3104, 3106 attached. In this example, in addition to or alternatively to the electrical contact-based and/or mechanical-based safety mechanism described above, the sensor safety mechanism may comprise a non-contact optical or electromagnetic sensor. For example, the sensor mechanism may comprise of one or more detectors or sensors (such as an optical sensor, Hall-effect sensor, capacitive sensor) 3702 configured to detect a detectable feature of the massage node 3104, 3106 when the massage node 3104, 3106 is present and properly attached to the piston 3202. A detectable feature, as used herein, refers to any physical characteristic, property, element, or structure of the massage node 3104, 3106 that is capable of being detected or sensed by the sensor 3702, including but not limited to an embedded magnet, a conductive target, a reflective surface, a dielectric target, or a physical structure of the massage node 3104, 3106 itself. As with the electrical and mechanical safety mechanisms described above, the sensor safety mechanism may be implemented as a direct-circuit hardware interlock, as a controller-monitored interlock, or as a combination of both.

In one example, the sensor mechanism may comprise of an emitter 3704, such as an infrared (IR) emitter (e.g., an IR LED), and a detector 3702, such as an IR detector (e.g., a phototransistor or photodiode), arranged in a configuration such that the IR beam emitted by the emitter 3704 is reflected by, interrupted by, or transmitted through a detectable feature of the massage node 3104, 3106 when the massage node 3104, 3106 is present and properly positioned on piston 3202. The sensor safety mechanism may operate in a reflective mode (where the IR beam emitted from emitter 3704 is reflected off a reflective surface of the massage node 3104, 3106 back to the detector 3702), a break-beam mode (where a physical structure of the massage node 3104, 3106 interrupts an IR beam emitted from emitter 3704 that would otherwise reach the detector 3702), or a transmissive mode (where the IR beam emitted from emitter 3704 passes through a detectable feature of the massage node 3104, 3106 to reach the detector 3702).

In other embodiments, the sensor safety mechanism may incorporate one or more sensors 3702, absent any emitter 3704, that detects and/or senses a detectable feature of massage node 3104, 3106 only when massage node 3104, 3106 is present and correctly positioned. Unlike non-mechanical or non-electrical contact methods, this sensor-based safety method is especially valuable in environments where mechanical switches or electrical conductive contacts may degrade due to repeated use, contamination, or physical damage. Because the sensor 3702 does not require physical contact between the sensing element and the massage node 3104, 3106, it is immune to contact wear, contact corrosion, and contact resistance degradation that may affect electrical contact-based or mechanical switch-based detection subsystems over time. This may make the sensor-based approach particularly suitable for percussion massagers intended for high-frequency use in harsh environments (e.g., fitness centers, outdoor athletic settings, clinical treatment rooms) where exposure to sweat, moisture, dust, and cleaning chemicals may accelerate degradation of contact-based systems.

The sensor 3702 may also be implemented using Hall-effect sensors and corresponding magnets (not shown) embedded in massage node 3104, 3106, allowing for magnetic detection of node presence and alignment. Other sensor technologies may include capacitive touch sensors or inductive coupling systems. In the Hall-effect sensor implementation, one or more small permanent magnets (e.g., neodymium or ferrite magnets) are embedded in the proximal portion of the massage node 3104, 3106 and one or more Hall-effect sensors are disposed on or near the distal end 3216 of the piston 3202 or within the forward housing portion 3110 of the massager housing 3102. When the massage node 3104, 3106 is properly attached, the embedded magnets are brought into proximity with the Hall-effect sensors 3702, generating a magnetic field that is detected by the Hall-effect sensors 3702. The Hall-effect sensors 3702 output a voltage signal proportional to the detected magnetic field strength. This signal may be used to control a hardware switching element as described below, or may be processed by the PCB/controller 3208 to determine whether proper node attachment is indicated.

In a capacitive sensing implementation, one or more capacitive sensor electrodes 3702 are disposed on or near the distal end 3216 of the piston 3202, and the massage node 3104, 3106 includes a corresponding conductive or dielectric target element(s) (e.g., a conductive contact medium such as an aluminum or stainless-steel plate). When the massage node 3104, 3106 is properly attached, the target element alters the capacitance measured by the capacitive sensor electrodes 3702, and this change in capacitance may be used to control a hardware switching element or may be detected by the PCB/controller 3208, as an indication of proper node attachment.

In an inductive coupling implementation, an induction coil 3702 is disposed on or near the distal end 3216 of the piston 3202, and the massage node 3104, 3106 includes a corresponding induction coil or conductive target. When the massage node 3104, 3106 is properly attached, the proximity of the coils or target in massage node 3104, 3106 alters the inductance or impedance measured by the primary coil 3702, and this change may be used to control a hardware switching element or may be detected by the PCB/controller 3208. Inductive coupling may also serve the dual purpose of providing contactless power transfer to active components within the temperature-controlled massage node 3104, such as a thermoelectric heating/cooling device, fan, or temperature sensor, in addition to providing safety interlock detection.

The sensor 3702 may be configured to control a hardware switching element that is wired in series with the motor power delivery circuit, such that the motor 3204 is physically incapable of receiving power unless the sensor 3702 detects or senses the presence of a properly attached massage node 3104, 3106. In this direct-circuit sensor hardware interlock, the output of the sensor 3702 drives a hardware switching element, such as a relay, a transistor, or a solid-state relay, that is disposed in series with the motor power delivery circuit. When the sensor 3702 does not detect the presence of a properly attached massage node 3104, 3106, the sensor output signal maintains the hardware switching element in an open (non-conducting) state, and the motor power delivery circuit remains physically interrupted. When the sensor 3702 detects the presence of a properly attached massage node 3104, 3106, the sensor output signal transitions the hardware switching element to a closed (conducting) state, permitting electrical power to flow to the motor 3204.

Unlike the direct-circuit electrical interlock and the direct-circuit mechanical interlock described above, the direct-circuit sensor hardware interlock does not rely on the massage node 3104, 3106 itself physically closing the motor power delivery circuit. Instead, the sensor 3702 detects the presence of the massage node 3104, 3106 through a non-contact sensing method (e.g., optical, magnetic, capacitive, or inductive detection), and the sensor output signal controls a separate hardware switching element that opens or closes the motor power delivery circuit.

Alternatively, or in addition to the direct-circuit sensor hardware interlock described above, the sensor safety mechanism may be implemented as a controller-monitored interlock. In this alternative embodiment, the output of the sensor 3702 is connected to a sensing input on the PCB/controller 3208, and the PCB/controller 3208 processes the sensor output signal to determine whether the massage node 3104, 3106 is present and properly attached. In the controller-monitored embodiment, the sensor 3702 outputs a signal indicative of the presence or absence of massage node 3104, 3106. This signal is processed by the PCB/controller 3208 to determine whether motor 3204 operation is permitted. A disruption or loss of the expected signal pattern (e.g., due to removal or improper attachment of the node 3104, 3106) results in immediate shutdown of motor 3204, thereby acting as a sensor kill switch or optical sensor kill switch.

It should be understood that all features and functions described in connection with the electrical safety mechanism are equally applicable to the sensor safety mechanism described herein. In particular, all types of interchangeable massage nodes described in connection with the electrical safety mechanism, including temperature-controlled massage nodes, light therapy massage nodes, and ultrasonic vibration massage nodes, may be used with the sensor safety mechanism. Further, the node identification system, including resistive identification, digital identification, and all other identification methods described in connection with the electrical safety mechanism, may be incorporated into embodiments employing the sensor safety mechanism. When the sensor safety mechanism is used in combination with electrical contacts (e.g., in a multi-layer redundancy configuration), the PCB/controller 3208 may identify the type of massage node attached and automatically adjust the operational parameters, user control interface, and indicator display in the same manner as described in connection with the electrical safety mechanism. When the sensor safety mechanism is used without electrical contacts, the sensor 3702 itself may serve a dual function of both detecting the presence of the massage node and identifying the node type. For example, in a Hall-effect sensor implementation, different massage node types may include magnets of different field strengths or in different arrangements, and the PCB/controller 3208 may identify the node type based on the detected magnetic field pattern. In a capacitive or inductive sensor implementation, different massage node types may present different capacitive or inductive signatures that the PCB/controller 3208 may use to identify the node type. Upon identification, the PCB/controller 3208 adjusts the operational parameters, user control interface, and indicator display accordingly.

As stated above, all the safety mechanisms described above may operate independently, in parallel or in series to achieve redundancy and improve reliability. For instance, both the electrical safety system and a mechanical safety system may be required to validate node presence, providing dual verification before enabling motor 3204. The multi-layer redundancy approach may be implemented entirely as direct-circuit hardware interlocks, entirely as controller-monitored interlocks, or as a combination of both. For example, if the spring-loaded pins 3302 become contaminated or corroded such that the electrical contact-based subsystem fails to detect proper attachment, the mechanical switch 3602 or sensor 3702 can still independently detect the presence of the massage node 3104, 3106 to maintain safe operation, and vice versa.

As also illustrated in the figures, namely, FIG. 34, massage node 3104, 3106 may be removably attached or connected to piston 3202 via a threading mechanism 3410 (also referred to herein as a threaded connection), which may be a standard screw-type thread or a custom-designed thread profile optimized for high-vibration and percussive movement environments. Such threading attachment mechanism ensures axial retention and minimizes the likelihood of unintentional detachment during operation. The threading mechanism 3410 may be, for example, a multi-start thread (e.g., a double-start or triple-start thread) that allows for rapid engagement and disengagement of the massage node 3104, 3106 with fewer rotational turns compared to a single-start thread, thereby improving user convenience during massage node interchange. The thread pitch, lead angle, and number of starts may be selected to balance rapid engagement speed against axial retention force, ensuring that the threading provides sufficient resistance to unintentional loosening under percussive loading while still permitting easy hand-tightening by the user without tools.

The mechanical threaded connection between the massage node 3104, 3106 and the piston 3202 also ensures consistent alignment of the electrical contacts, mechanical switches, and/or sensors described herein, thereby ensuring reliable operation of the safety mechanism. In certain embodiments, the threading mechanism 3410 includes an end-stop or positive stop that prevents over-tightening of the massage node 3104, 3106 and ensures that the massage node 3104, 3106 is consistently positioned at the same axial depth relative to the piston 3202 each time it is attached. This consistent positioning ensures that the electrical contacts 3302, 3402 are brought into contact at a consistent pressure, that the mechanical switch 3602 is depressed to a consistent depth, and that the sensor 3702 receives a consistent signal level, all of which contribute to reliable and repeatable safety mechanism operation. Consistent axial positioning is particularly important in the direct-circuit hardware interlock embodiments because the motor power delivery circuit depends on a reliable physical electrical closure of the electrical contacts 3302, 3402 and/or the mechanical switch 3602. Inconsistent positioning could result in intermittent contact closure that causes unpredictable motor behavior.

It should be understood that other attachment mechanisms known in the art may also be incorporated, including but not limited to friction fit, magnetic attachments, press studs, clips, or snap-fit connectors. Each of these alternative attachment mechanisms may be designed to interface with the safety mechanism described herein. For example, a magnetic attachment mechanism may utilize embedded magnets that also serve as the magnetic targets for a Hall-effect sensor-based safety mechanism. A snap-fit connector may be designed such that the snap-fit engagement actuates a mechanical switch integrated into the snap-fit mechanism. A friction-fit mechanism may be designed with sufficient dimensional tolerance to ensure that the electrical contacts on the massage node make reliable contact with the corresponding contacts on the piston only when the node is fully seated. In each case, the alternative attachment mechanism is compatible with the direct-circuit hardware interlock, the controller-monitored interlock, or a combination of both, as described herein.

In operation, a user of the percussion massager 3100 performs the following general sequence to use the device. First, the user selects a desired massage node from the available interchangeable nodes, for example one of the dummy massage nodes 3106 or temperature-controlled massage node 3104. The user then attaches the selected massage node 3104, 3106 to the piston 3202 by engaging the threading mechanism 3410 (or other applicable attachment mechanism) until the massage node 3104, 3106 is fully seated against the distal end 3216 of the piston 3202. Upon full seating, the electrical contacts 3302 on the piston 3202 make electrical contact with the corresponding electrical contacts 3402 on the massage node 3104, 3106, thereby establishing a first electrical connection between electrical contacts 3302 and electrical contacts 3402. If a mechanical switch 3602 is present, the proximal face of the massage node 3104, 3106 depresses the switch 3602 upon full seating. If a sensor 3702 is present, the sensor 3702 detects the detectable feature or presence of the massage node 3104, 3106 upon full seating. In embodiments employing a direct-circuit hardware interlock, the act of fully seating the massage node 3104, 3106 physically completes the motor power delivery circuit (or electrical power path). Establishing the first electrical connection enables operation of the motor 3204. Conversely, when the massage node 3104, 3106 is not attached to the piston 3202 and the first electrical connection is not established, operation of the motor 3204 is inhibited. The controller 3208, if monitoring the connection state, may provide a visual indication to the user regarding the attachment state of the massage node 3104, 3106.

Next, the user activates the percussion massager 3100 by pressing the power button or otherwise engaging the user control interface 3114. In embodiments employing a direct-circuit hardware interlock, the PCB/controller 3208 responds to the user's activation input by enabling the motor driver circuit. If the massage node 3104, 3106 is properly attached, the motor power delivery circuit is complete and the motor 3204 begins to drive the piston 3202 in a reciprocating percussive motion. If the massage node 3104, 3106 is not properly attached, the motor 3204 does not operate.

In embodiments employing a controller-monitored interlock, upon activation, the PCB/controller 3208 executes a startup verification depending on the safety subsystem incorporated. If this check passes (i.e., the massage node 3104, 3106 is detected as properly attached), the PCB/controller 3208 enables the motor driver circuit, and the motor 3204 begins to drive the piston 3202 in a reciprocating percussive motion. If the check fails, the PCB/controller 3208 prevents motor activation and may alert the user through the indicator display 3114 (e.g., by illuminating a red LED or displaying an error code).

In embodiments employing a combined direct-circuit and controller-monitored approach, both layers operate simultaneously. The direct-circuit hardware interlock physically prevents motor operation unless the massage node 3104, 3106 is properly attached, while the controller-monitored interlock provides startup verification, user-facing feedback, and diagnostic capabilities.

During operation, the safety mechanism continuously ensures that the massage node 3104, 3106 remains properly attached. In embodiments employing a direct-circuit hardware interlock, if the massage node 3104, 3106 becomes dislodged or loosened during operation, the electrical contacts 3302, 3402 separate and/or the mechanical switch 3602 opens, and power delivery to the motor 3204 ceases instantaneously. In embodiments employing a controller-monitored interlock, the PCB/controller 3208 disables the motor 3204 upon detecting the change in attachment state. The user is alerted to the condition through the indicator display 3114, and the user must re-attach the massage node 3104, 3106 and re-initiate operation of the massager 3100 before the percussion massager 3100 can resume operation.

When the user wishes to interchange massage nodes during a therapy session, the user first powers off the percussion massager 3100 or waits for the motor 3204 to come to a complete stop, although the safety mechanism will disable the motor 3204 if the user attempts to remove the massage node during operation. The user then detaches the current massage node 3104, 3106 by disengaging the threading mechanism 3410 (or other applicable attachment mechanism), thereby breaking the first electrical connection, selects a new massage node 3104, 3106 (which may include one or more electrical contacts that differ in number from the electrical contacts on the first massage node), and attaches the new node to the piston 3202, thereby establishing a second electrical connection between the electrical contacts 3302 on the piston 3202 and the electrical contacts on the new massage node. Upon re-activating the percussion massager 3100, the safety mechanism confirms proper attachment of the new massage node 3104, 3106 before permitting motor operation. If the new massage node includes an active component, such as a thermoelectric heater/cooler, the active component may receive electrical power from the power source 3206 through the second electrical connection.

It will be understood, and is appreciated by persons skilled in the art, that one or more processes, sub-processes, or process steps described above may be performed by hardware and/or software. If the process is performed by software, the software may reside in software memory (not shown) in a suitable electronic processing component or system. The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer readable medium” is any means that may contain, store or communicate the program for use by or in connection with the instruction execution system, apparatus, or device. The computer readable medium may selectively be, for example, but is not limited to, an electronic, magnetic, optical, electromagnetic, infrared, or semiconductor system, apparatus or device. More specific examples, but nonetheless a non-exhaustive list, of computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It will be understood that the term “in signal communication” as used herein means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

More generally, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

The foregoing description of an implementation has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

1. A percussion massager comprising:
a massager housing;
a power source;
a motor disposed within the massager housing, wherein the motor is configured to receive power from the power source;
a piston in operative communication with the motor and configured to reciprocate relative to the massager housing, the piston having a distal end;
a massage node removably attachable to the distal end of the piston; and
a safety mechanism comprising a first component disposed on the piston and a second component disposed on the massage node, wherein the first component and the second component are configured to interact when the massage node is attached to the piston, and wherein the motor is operable when the first component and the second component are interacting and inoperable when the first component and the second component are not interacting.

2. The percussion massager of claim 1, wherein the first component comprises one or more first electrical contacts disposed on or near the distal end of the piston, and the second component comprises one or more second electrical contacts disposed on the massage node, and wherein the first component and the second component interact by the one or more first electrical contacts making electrical contact with the one or more second electrical contacts when the massage node is attached to the piston.

3. The percussion massager of claim 2, wherein the one or more first electrical contacts and the one or more second electrical contacts are electrically interposed between the power source and the motor.

4. The percussion massager of claim 3, wherein the motor receives power from the power source through an electrical power path between the power source and the motor, and wherein the one or more first electrical contacts and the one or more second electrical contacts are wired in series with the electrical power path such that the electrical power path is in an open state when the one or more first electrical contacts are not in electrical contact with the one or more second electrical contacts and in a closed state when the one or more first electrical contacts are in electrical contact with the one or more second electrical contacts.

5. The percussion massager of claim 1, wherein the first component comprises a mechanical switch disposed on or near the distal end of the piston, and the second component comprises a portion of the massage node, and wherein the first component and the second component interact by the second component actuating the mechanical switch when the massage node is attached to the piston.

6. The percussion massager of claim 5, wherein the portion of the massage node that actuates the mechanical switch comprises a surface of the massage node that presses against the mechanical switch when the massage node is attached to the piston.

7. The percussion massager of claim 5, wherein the mechanical switch is wired in series with an electrical circuit between the power source and the motor such that the motor is prevented from receiving electrical power from the power source when the mechanical switch is not actuated.

8. The percussion massager of claim 1, wherein the first component comprises a sensor disposed on or near the distal end of the piston or within the massager housing, and the second component comprises a detectable feature configured to be detected by the sensor, and wherein the first component and the second component interact by the sensor detecting the detectable feature when the massage node is attached to the piston.

9. The percussion massager of claim 8, wherein the detectable feature comprises at least one of: a magnet embedded in the massage node, a conductive target disposed on the massage node, a reflective surface on the massage node, a dielectric target disposed on the massage node, or a physical structure of the massage node.

10. The percussion massager of claim 8, wherein the sensor comprises at least one of: an infrared emitter-detector, a Hall-effect sensor, a capacitive sensor, or an inductive coupling sensor.

11. The percussion massager of claim 1, further comprising a controller, wherein the controller is configured to monitor a state of interaction between the first component and the second component and to disable operation of the motor when the first component and the second component are not interacting with each other.

12. The percussion massager of claim 11, wherein the controller is further configured to identify a type of the massage node based on a characteristic of the state of interaction, and to adjust one or more operational parameters of the percussion massager in response to the identified type of the massage node.

13. The percussion massager of claim 1, wherein the massage node is removably attachable to the distal end of the piston via a threaded connection.

14. A percussion massager comprising:
a massager housing;
a motor disposed within the massager housing;
a power source configured to supply electrical power to the motor through an electrical power path between the power source and the motor;
a piston driven by the motor in a reciprocating motion within the massager housing, the piston having a distal end;
one or more first electrical contacts disposed on or near the distal end of the piston and positioned within the electrical power path;
a massage node removably attachable to the distal end of the piston, the massage node comprising one or more second electrical contacts positioned within the electrical power path and configured to make electrical contact with the one or more first electrical contacts when the massage node is attached to the piston, wherein the electrical power path is interrupted at an interface between the piston and the massage node when the massage node is not attached to the piston, and wherein the electrical power path is continuous through the interface when the massage node is attached to the piston.

15. The percussion massager of claim 14, wherein one of the one or more first electrical contacts or the one or more second electrical contacts comprises electrical pins and the other comprises electrical plates, wherein the electrical plates are concentrically arranged, and wherein each electrical pin is radially positioned to electrically contact a different one of the concentric electrical plates independent of a rotational orientation of the massage node when attached to the piston.

16. The percussion massager of claim 14, wherein the massage node is a first massage node comprising at least two second electrical contacts electrically interconnected within the first massage node by a conductive pathway, the at least two second electrical contacts configured to close an electrical circuit between the power source and the motor when the first massage node is attached to the piston.

17. A percussion massager comprising:
a massager housing;
a motor disposed within the massager housing;
a power source;
a piston driven by the motor in a reciprocating motion within the massager housing, the piston having a distal end;
one or more first electrical contacts disposed on or near the distal end of the piston;
a massage node removably attachable to the distal end of the piston, the massage node comprising one or more second electrical contacts configured to make electrical contact with the one or more first electrical contacts when the massage node is attached to the piston; and
a controller in communication with the motor and configured to determine a connection state between the one or more first electrical contacts and the one or more second electrical contacts, wherein the controller is configured to enable operation of the motor when the connection state indicates electrical contact and to disable operation of the motor when the connection state does not indicate electrical contact.

18. The percussion massager of claim 17, wherein the controller is configured to monitor the connection state during operation of the motor and to disable operation of the motor upon detecting a change in the connection state.

19. The percussion massager of claim 17, further comprising an indicator display disposed on the massager housing, wherein the controller is configured to activate the indicator display to alert a user when the connection state does not indicate electrical contact.

20. The percussion massager of claim 17, wherein the controller is further configured to identify a type of the massage node.
